(19) United States
(12) Patent Application Publication
(10) Pub. No.: US 2015/0031326 A1
(43) Pub. Date: Jan. 29, 2015

(54) High Level Operating System Application Use Case Identification System to Improve User Experience

(71) Applicant: QUALCOMM Incorporated, San Diego, CA (US)

(72) Inventors: Henri BEGIN, Lyons, CO (US); Jeffrey NIEMANN, Superior, CO (US); Jon ANDERSON, Boulder, CO (US); Richard STEWART, San Diego, CA (US); Francis NGAI, San Diego, CA (US)

(73) Assignee: QUALCOMM Incorporated, San Diego, CA (US)

(21) Appl. No.: 13/949,389

(22) Filed: Jul. 24, 2013

(51) Int. Cl. H04W 24/02; H04W 72/04

(52) U.S. Cl. CPC H04W 24/02; H04W 72/0493
USPC 455/405

(57) ABSTRACT

Methods, devices, and systems for a mobile device to execute user experience software that dynamically determines operating policies that are suited for managing resources, such as transceivers, processors, and other units within the mobile device. In an aspect, a processor executing the user experience software may monitor for activity information that indicates a user's interactions with the mobile device. Based on the activity information, a processor executing the user experience software may match a circumstance defined by the activity information with a stored activity profile. The activity profile may include information indicating aggregated resource usage associated with the matched circumstance. A processor executing the user experience software may implement an operating policy based on the activity profile that manages how the mobile device utilizes resources. In various aspects, activity profiles may be periodically updated with resource usage information from numerous sources to aggregate data for managing particular circumstances.

### BACKGROUND

As mobile devices become ubiquitous, the available functionalities and extent of use of mobile services are increasing exponentially. Like desktop computers, mobile devices are now used to run multiple simultaneous applications, allowing users to perform many complex operations, such as email friends, check calendar appointments, and surf the Internet. Mobile devices may also include numerous hardware components to facilitate such expansive use, such as graphics processing units (GPUs), geolocation units (e.g., GPS chip), various antennae and wireless signaling units (e.g., Bluetooth, WiFi, cellular network transceivers, etc.), and user interfaces (e.g., touchscreens, voice command units, etc.). Many mobile devices can be configured to utilize more than one subscription (or SIM card)/technology to provide concurrent voice and/or data services to users, further increasing the complexity of the operations of mobile devices.

However, such dense capabilities and use do not come without a cost. Mobile devices supporting expansive operations and components may employ operating policies that delimit resources to ensure the devices continue to function in convenient, useful manners. In particular, mobile devices may restrict operations based on conditions such as available power (e.g., using battery current limiting or “BCL”), governmental regulations directed to RF radiation (e.g., using FCC specific absorption rates or “SAR”), thermal limits, antenna interference, and other device constraints. Limits management systems may be used to implement operating policies to manage mobile device components and improve performance in the presence of these various restrictive conditions (i.e., manage the device to comply with government, safety and practical limits). Presently, the policies used by limits management systems of mobile devices are prescribed by application/component designers and are static, thus failing to incorporate real-time actions from end users when adjusting operating priorities.

### SUMMARY

In an aspect, a mobile device may perform a method for dynamically improving user experience including periodically aggregating usage information and storing the aggregated usage information within a stored activity profile, wherein the usage information may include data from application programming interface (API) messages that may indicate resource usage, detecting a current circumstance based on activity information that is associated with the stored activity profile, determining an operating policy based on the aggregated usage information of the stored activity profile, and managing resources of the mobile device based on the determined operating policy. In an aspect, periodically aggregating usage information and storing the aggregated usage information within the stored activity profile may include obtaining the usage information including metadata indicating characteristics of the current circumstance, data from the API messages, and from current usage data from hardware, software, and firmware, aggregating the obtained usage information, and storing the aggregated usage information in a database in relation to the current circumstance. In an aspect, obtaining current usage data from hardware, software, and firmware may include gathering messages that are transmitted while the current circumstance exists, in which the gathered messages may indicate at least one of device temperatures, software notifications, firmware notifications, and power meters. In an aspect, the operating policy may indicate at least one of a subscription/technology priority, a power consumption threshold, a thermal threshold, an activation/energized state, and a frequency for performing operations associated with a subsystem. In an aspect, detecting a current circumstance based on activity information that is associated with the stored activity profile may include monitoring current activity information related to user activity, and identifying the current circumstance based on the monitored current activity information, and the monitored current activity may include at least one a current application executing at a foreground, an interrupt, a detected user input, a state of an operating system, sensor data, a time of day, a user credential, and location information. In an aspect, determining an operating policy based on the aggregated usage information of the stored activity profile may include determining whether the current circumstance has changed from a previous circumstance, matching the current circumstance to the stored activity profile when the current circumstance has changed, obtaining the aggregated usage information from the matched activity profile, and determining the operating policy based on the obtained aggregated usage information. In an aspect, determining an operating policy based on the aggregated usage information of the stored activity profile may include matching the current circumstance to the stored activity profile, determining whether the current circumstance has changed from a previous circumstance, determining whether usage information in the matched activity profile has changed from a previous state, obtaining the aggregated usage information from the matched activity profile when the current circumstance has changed, obtaining the aggregated usage information from the matched activity profile when usage information in the stored activity profile has changed, and determining the operating policy based on the obtained aggregated usage information. In an aspect, determining an operating policy based on the aggregated usage information of the stored activity profile may include adjusting an existing operating policy based on the aggregated usage information of the stored activity profile. In an aspect, detecting a circumstance may include determining that a new application has been selected to execute in a foreground of an operating system, and determining an operating policy based on the aggregated usage information of the stored activity profile may include identifying an application identifier for the new application that has been selected, matching the identified application identifier to the stored activity profile, obtaining the aggregated usage information from the matched activity profile, and determining the operating policy based on the obtained aggregated usage information. In an aspect, managing resources of the mobile device based on the determined operating policy may include at least one of adjusting a power consumption, adjusting a processing frequency, performing blanking based on priorities, and changing an activation state. In an aspect, managing resources of the mobile device based on the determined operating policy may include determining whether the determined operating policy will result in an unwanted operating condition, managing resources of the mobile device based on the determined operating policy when the determined operating policy will not result in the unwanted operating condition, and overriding the determined operating policy when the determined operating policy will result in the unwanted operating condition.

In another aspect, a mobile device may include means for periodically aggregating usage information and storing the aggregated usage information within a stored activity profile, wherein the usage information may include data from application programming interface (API) messages that may indicate resource usage, means for detecting a current circumstance based on activity information that is associated with the stored activity profile, means for determining an operating policy based on the aggregated usage information of the stored activity profile, and means for managing resources of the mobile device based on the determined operating policy. In an aspect, means for periodically aggregating usage information and storing the aggregated usage information within the stored activity profile may include means for obtaining the usage information including metadata indicating characteristics of the current circumstance, data from the API messages, and from current usage data from hardware, software, and firmware, means for aggregating the obtained usage information, and means for storing the aggregated usage information in a database in relation to the current circumstance. In an aspect, means for obtaining current usage data from hardware, software, and firmware may include means for gathering messages that are transmitted while the current circumstance exists, wherein the gathered messages may indicate at least one of device temperatures, software notifications, firmware notifications, and power meters. In an aspect, the operating policy may indicate at least one of a subscription/technology priority, a power consumption threshold, a thermal threshold, an activation/energized state, and a frequency for performing operations associated with a subsystem. In an aspect, means for detecting a current circumstance based on activity information that is associated with the stored activity profile may include means for monitoring current activity information related to user activity, and means for identifying the current circumstance based on the monitored current activity information, wherein the monitored current activity may include at least one a current application executing at a foreground, an interrupt, a detected user input, a state of an operating system, sensor data, a time of day, a user credential, and location information. In an aspect, means for determining an operating policy based on the aggregated usage information of the stored activity profile may include means for determining whether the current circumstance has changed from a previous circumstance, means for matching the current circumstance to the stored activity profile when the current circumstance has changed, means for obtaining the aggregated usage information from the matched activity profile, and means for determining the operating policy based on the obtained aggregated usage information. In an aspect, means for determining an operating policy based on the aggregated usage information of the stored activity profile may include means for matching the current circumstance to the stored activity profile, means for determining whether the current circumstance has changed from a previous circumstance, means for determining whether usage information in the matched activity profile has changed from a previous state, means for obtaining the aggregated usage information from the matched activity profile when the current circumstance has changed, means for obtaining the aggregated usage information from the matched activity profile when usage information in the stored activity profile has changed, and means for determining the operating policy based on the obtained aggregated usage information. In an aspect, means for determining an operating policy based on the aggregated usage information of the stored activity profile may include means for adjusting an existing operating policy based on the aggregated usage information of the stored activity profile. In an aspect, means for detecting a circumstance may include determining that a new application has been selected to execute in a foreground of an operating system, and means for determining an operating policy based on the aggregated usage information of the stored activity profile may include means for identifying an application identifier for the new application that has been selected, means for matching the identified application identifier to the stored activity profile, means for obtaining the aggregated usage information from the matched activity profile, and means for determining the operating policy based on the obtained aggregated usage information. In an aspect, means for managing resources of the mobile device based on the determined operating policy may include at least one of means for adjusting a power consumption, means for adjusting a processing frequency, means for performing blanking based on priorities, and means for changing an activation state. In an aspect, means for managing resources of the mobile device based on the determined operating policy may include means for determining whether the determined operating policy will result in an unwanted operating condition, means for managing resources of the mobile device based on the determined operating policy when the determined operating policy will not result in the unwanted operating condition, and means for overriding the determined operating policy when the determined operating policy will result in the unwanted operating condition.

In another aspect, a mobile device may include a memory and a processor coupled to the memory and configured with processor-executable instructions to perform operations including periodically aggregating usage information and storing the aggregated usage information within a stored activity profile, wherein the usage information may include data from application programming interface (API) messages that may indicate resource usage, detecting a current circumstance based on activity information that is associated with the stored activity profile, determining an operating policy based on the aggregated usage information of the stored activity profile, and managing resources of the mobile device based on the determined operating policy. In an aspect, the processor may be configured with processor-executable instructions to perform operations such that periodically aggregating usage information and storing the aggregated usage information within the stored activity profile may include obtaining the usage information including metadata indicating characteristics of the current circumstance, data from the API messages, and from current usage data from hardware, software, and firmware, aggregating the obtained usage information, and storing the aggregated usage information in a database in relation to the current circumstance. In an aspect, the processor may be configured with processor-executable instructions to perform operations such that obtaining current usage data from hardware, software, and firmware may include gathering messages that are transmitted while the current circumstance exists, wherein the gathered messages may indicate at least one of device temperatures, software notifications, firmware notifications, and power meters. In an aspect, the operating policy may indicate at least one of a subscription/technology priority, a power consumption threshold, a thermal threshold, an activation/energized state, and a frequency for performing operations associated with a subsystem. In an aspect, the processor may be configured with processor-executable instructions to perform operations such that detecting a current circumstance based on activity information that is associated with the stored activity profile may include monitoring current activity information related to user activity, and identifying the current circumstance based on the monitored current activity information, wherein the monitored current activity may include at least one a current application executing at a foreground, an interrupt, a detected user input, a state of an operating system, sensor data, a time of day, a user credential, and location information. In an aspect, the processor may be configured with processor-executable instructions to perform operations such that determining an operating policy based on the aggregated usage information of the stored activity profile may include determining whether the current circumstance has changed from a previous circumstance, matching the current circumstance to the stored activity profile when the current circumstance has changed, obtaining the aggregated usage information from the matched activity profile, and determining the operating policy based on the obtained aggregated usage information. In an aspect, the processor may be configured with processor-executable instructions to perform operations such that determining an operating policy based on the aggregated usage information of the stored activity profile may include matching the current circumstance to the stored activity profile, determining whether the current circumstance has changed from a previous circumstance, determining whether usage information in the matched activity profile has changed from a previous state, obtaining the aggregated usage information from the matched activity profile when the current circumstance has changed, obtaining the aggregated usage information from the matched activity profile when usage information in the stored activity profile has changed, and determining the operating policy based on the obtained aggregated usage information. In an aspect, the processor may be configured with processor-executable instructions to perform operations such that determining an operating policy based on the aggregated usage information of the stored activity profile may include adjusting an existing operating policy based on the aggregated usage information of the stored activity profile. In an aspect, the processor may be configured with processor-executable instructions to perform operations such that detecting a circumstance may include determining that a new application has been selected to execute in a foreground of an operating system, and wherein the processor may be configured with processor-executable instructions to perform operations such that determining an operating policy based on the aggregated usage information of the stored activity profile may include identifying an application identifier for the new application that has been selected, matching the identified application identifier to the stored activity profile, obtaining the aggregated usage information from the matched activity profile, and determining the operating policy based on the obtained aggregated usage information. In an aspect, the processor may be configured with processor-executable instructions to perform operations such that managing resources of the mobile device based on the determined operating policy may include at least one of adjusting a power consumption, adjusting a processing frequency, performing blanking based on priorities, and changing an activation state. In an aspect, the processor may be configured with processor-executable instructions to perform operations such that managing resources of the mobile device based on the determined operating policy may include determining whether the determined operating policy will result in an unwanted operating condition, managing resources of the mobile device based on the determined operating policy when the determined operating policy will not result in the unwanted operating condition, and overriding the determined operating policy when the determined operating policy will result in the unwanted operating condition.

Another aspect may include a non-transitory processor-readable storage medium on which are stored processor-executable software instructions configured to cause a processor to perform operations including periodically aggregating usage information and storing the aggregated usage information within a stored activity profile, wherein the usage information may include data from application programming interface (API) messages that may indicate resource usage, detecting a current circumstance based on activity information that is associated with the stored activity profile, determining an operating policy based on the aggregated usage information of the stored activity profile, and managing resources of the mobile device based on the determined operating policy. In an aspect, the stored processor-executable software instructions may be configured to cause the processor to perform operations such that periodically aggregating usage information and storing the aggregated usage information within the stored activity profile may include obtaining the usage information including metadata indicating characteristics of the current circumstance, data from the API messages, and from current usage data from hardware, software, and firmware, aggregating the obtained usage information, and storing the aggregated usage information in a database in relation to the current circumstance. In an aspect, the stored processor-executable software instructions may be configured to cause the processor to perform operations such that obtaining current usage data from hardware, software, and firmware may include gathering messages that are transmitted while the current circumstance exists, wherein the gathered messages may indicate at least one of device temperatures, software notifications, firmware notifications, and power meters. In an aspect, the operating policy may indicate at least one of a subscription/technology priority, a power consumption threshold, a thermal threshold, an activation/energized state, and a frequency for performing operations associated with a subsystem. In an aspect, the stored processor-executable software instructions may be configured to cause the processor to perform operations such that detecting a current circumstance based on activity information that is associated with the stored activity profile may include monitoring current activity information related to user activity, and identifying the current circumstance based on the monitored current activity information, wherein the monitored current activity may include at least one a current application executing at a foreground, an interrupt, a detected user input, a state of an operating system, sensor data, a time of day, a user credential, and location information. In an aspect, the stored processor-executable software instructions may be configured to cause the processor to perform operations such that determining an operating policy based on the aggregated usage information of the stored activity profile may include determining whether the current circumstance has changed from a previous circumstance, matching the current circumstance to the stored activity profile when the current circumstance has changed, obtaining the aggregated usage information from the matched activity profile, and determining the operating policy based on the obtained aggregated usage information. In an aspect, the stored processor-executable software instructions may be configured to cause the processor to perform operations such that determining an operating policy based on the aggregated usage information of the stored activity profile may include matching the current circumstance to the stored activity profile, determining whether the current circumstance has changed from a previous circumstance, determining whether usage information in the matched activity profile has changed from a previous state, obtaining the aggregated usage information from the matched activity profile when the current circumstance has changed, obtaining the aggregated usage information from the matched activity profile when usage information in the stored activity profile has changed, and determining the operating policy based on the obtained aggregated usage information. In an aspect, the stored processor-executable software instructions may be configured to cause the processor to perform operations such that determining an operating policy based on the aggregated usage information of the stored activity profile may include adjusting an existing operating policy based on the aggregated usage information of the stored activity profile. In an aspect, the stored processor-executable software instructions may be configured to cause the processor to perform operations such that detecting a circumstance may include determining that a new application has been selected to execute in a foreground of an operating system, and wherein the stored processor-executable software instructions may be configured to cause the processor to perform operations such that determining an operating policy based on the aggregated usage information of the stored activity profile may include identifying an application identifier for the new application that has been selected, matching the identified application identifier to the stored activity profile, obtaining the aggregated usage information from the matched activity profile, and determining the operating policy based on the obtained aggregated usage information. In an aspect, the stored processor-executable software instructions may be configured to cause the processor to perform operations such that managing resources of the mobile device based on the determined operating policy may include at least one of adjusting a power consumption, adjusting a processing frequency, performing blanking based on priorities, and changing an activation state. In an aspect, the stored processor-executable software instructions may be configured to cause the processor to perform operations such that managing resources of the mobile device based on the determined operating policy may include determining whether the determined operating policy will result in an unwanted operating condition, managing resources of the mobile device based on the determined operating policy when the determined operating policy will not result in the unwanted operating condition, and overriding the determined operating policy when the determined operating policy will result in the unwanted operating condition.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a component block diagram of an aspect user experience software system implemented in a mobile device.

FIG. 2 is a process flow diagram illustrating an aspect method for a user experience software executing on a mobile device to implement an operating policy.

FIG. 3A is a process flow diagram illustrating an aspect method for a user experience software executing on a mobile device to implement an operating policy based changes in a user's activity.

FIG. 3B is a process flow diagram illustrating another aspect method for a user experience software executing on a mobile device to implement an operating policy based changes in a user's activity.

FIG. 4 is a process flow diagram illustrating another aspect method for a user experience software executing on a mobile device to implement an operating policy based changes in a user's activity.

FIG. 5 is a process flow diagram illustrating another aspect method for a user experience software executing on a mobile device to implement an operating policy based changes in a user's activity.

FIG. 6 is a process flow diagram illustrating an aspect method for a user experience software executing on a mobile device to aggregate and store data for use in determining operating policies based on a user's activity.

FIG. 7A is a process flow diagram illustrating an aspect method for a user experience software executing on a mobile device to implement various resource management operations of an operating policy.

FIG. 7B is a process flow diagram illustrating an aspect method for a user experience software executing on a mobile device to override an operating policy.

FIG. 8 is a process flow diagram illustrating an aspect method for a user experience software executing on a mobile device to implement an operating policy based on an activity profile that corresponds to an application executing in the foreground of the device.

FIG. 9 is a component block diagram of an example laptop computing device suitable for use with the various aspects.

FIG. 10 is a component block diagram of a smartphone-style mobile computing device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile computing device” or “mobile device” or “computing device” are used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with at least a processor. In various aspects, such devices may be configured with a network transceiver to establish a wide area network (WAN) or local area network (LAN) connection (e.g., an LTE, 3G or 4G wireless wide area network transceiver, a wired connection to the Internet, or WiFi).

The various aspects provide systems and methods for modifying the operations of a mobile device based on dynamic activity profiles to dynamically improve user experience via a user experience software or application. A processor of the mobile device may execute the user experience software as a routine, application, service, or other background process. A processor executing the user experience software may be configured to receive notifications, interrupts, flags, messages, status data, and other information from the mobile device's high-level operating system (HLOS) that indicate current activities of the device's user, which is referred to herein as “activity information.” For example, smart phone a processor executing the user experience software may receive a message from an Android® operating system indicating the user has pressed the touchscreen and initiated a social networking app. As another example, a processor executing the user experience software may receive activity information that indicates the mobile device has been configured to operate in a low-power state or configuration. The current activity information may include any information that indicates the user's intended activities, including a current time (e.g., time of day, day of week, etc.), the identity of the logged-in user of the mobile device, sensor data (e.g., accelerometer data, pressure sensor data, GPS sensor data, etc.), and/or the identity (or identities) of the app(s) executing in the foreground or background of an operating system of the mobile device. In an aspect, a processor executing the user experience software may utilize a listener routine/module that monitors for and reports activity information, such as by translating active process identifiers indicated by the HLOS into application identifiers (or app IDs).

A processor executing the user experience software may identify a circumstance based on the activity information. A circumstance may be a predefined set of activities (or activity information) that correspond to a certain operating situation or “use case.” Circumstances may be defined by a plurality of inputs or types of activity information, such as an active application in combination with a particular time of day or location of the mobile device. Alternatively, certain circumstances may be defined by a single activity, such as the identity (or app ID) of a particular application executing in the foreground of an operating system (or HLOS) of the mobile device. In various aspects, circumstances may be user-defined and/or predetermined by a manufacturer or developer.

A processor executing the user experience software may be configured to correlate or match an identified circumstance with a stored activity profile. For example, a code associated with a predefined circumstance may act as a look-up key for an activity profile stored in a relational database. The activity profile may be data that indicates particular operating conditions (e.g., system settings), limitations, and hardware use (or other resource use) associated with the user's current activity and/or circumstances. In other words, the activity profile tells a processor executing the user experience software how the resources of the mobile device are affected (or likely may be affected) during the existence of a certain circumstance. For example, a processor executing the user experience software may determine that a Bluetooth® stack/transceiver is utilized heavily when activity information indicates a particular video game application (or app) is loaded by the user of a smartphone. As another example, a processor executing the user experience software may match a circumstance defined by certain user activity with an activity profile that indicates use of a particular set of hardware blocks and/or heavy battery use that typically occurs over a period of several minutes. In an aspect, the activity profile may be associated with or defined by various characteristics related to resource use, such as identity of particular active applications (or apps), nature of active apps (e.g., music, text-based, gaming, etc.), time of day, day of the week, number of active apps, etc. In various aspects, a processor executing the user experience software may access information of the activity profile from a database that may be periodically updated by the user experience software, the HLOS, and/or other processes, threads, or operations performed by the mobile device.

A processor executing the user experience software may use the activity profile matched to the current circumstance to determine an operating policy (or a quality of service policy). In other words, a processor executing the user experience software may promote the best operating parameters or rules for managing the mobile device based on what the user is doing at a given time. For example, a processor executing the user experience software may determine an operating policy that adjusts system performance per hardware block based on a user's touchscreen inputs and/or active apps. Such a policy may include priorities of operations, technologies, applications, routines, and/or services concurrently executing on the mobile device. For example, the operating policy may include instructions that indicate that operations related to retrieving voice call data may have a higher priority than data call information, and thus the voice call operations may be performed to the exclusion of the data call operations. The operating policy may also include acceptable thresholds for various resources, such as radiation output, thermal output, and/or battery use (or power consumption). In other words, an operating policy may implement a subscription/technology priority, a power consumption threshold, a thermal threshold, an activation/energized state (e.g., whether a camera is on or off at a given time, etc.), and a frequency for performing operations associated with a subsystem (e.g., a radio subsystem, etc.).

In an aspect, a processor executing the user experience software may utilize a module, component, routines, or other particular operations (e.g., a Quality of Service translator) to determine operating policies, priorities, or mitigation rules, based on the information within the activity profile. For example, the Quality of Service policy module may reprioritize existing mitigation priorities within an implemented operating policy based on hardware use information from the activity profile.

A processor executing the user experience software may implement the determined operating policy related to the activity profile, such as by providing rules, thresholds, or parameters to a limits management software (or engine). In an aspect, a processor executing the user experience software may adjust a currently implemented operating policy based on the activity profile matched to a current circumstance. For example, when a processor executing the user experience software detects that a new circumstance matches an activity profile indicating a high thermal output, the current operating policy may be adjusted to implement a more aggressive thermal mitigation.

In an aspect, the operating policy may be transmitted to a limits management software module that may re-balance operations (e.g., mitigation operations) based on the current user activities. The operating policy may configure the mobile device to prioritize one subscription/technology over another (e.g., voice over data), deactivate components (e.g., turn a camera unit “off”), and/or change the frequency (or processing frequency) of operations associated with various mobile device subsystems or components (e.g., configure a transceiver controller to search for access points at a slower/faster rate, configure a CPU/processing chip to slow down to decrease thermal output or power consumption, etc.). For example, using the operating policy, the limits management software may configure cellular networking subsystems to perform their operations at a lower frequency. In various aspects, the operating policy may be executed in part or not at all based on current operating conditions. For example, when the activity profile indicates current activities may cause significant thermal output, a processor executing the user experience software may make exceptions to or override the determined operating policy to prohibit subsystem operations that may exceed satisfactory heat thresholds (i.e., policy exceptions may occur to mitigate critical conditions). In an aspect, a processor executing the user experience software may ignore or otherwise nullify API messages when such API messages may cause an operating policy that is dangerous or likely to result in unwanted or suboptimal operating conditions of the mobile device. For example, a processor executing the user experience software may override an API message request for a high number of processing cycles for an app when the request would cause a dangerous increase in device temperatures.

The various aspects may be understood by considering an illustration in which the mobile device executing a processor executing the user experience software receives a user input to start a navigation app. Informed that this app is starting, a processor executing the user experience software may perform a look-up in a database using an identifier associated with the navigation app, obtaining an activity profile that includes stored data describing previous hardware use associated with the navigation app. Based on the obtained profile of the navigation app, a processor executing the user experience software may cause a mitigation policy to be adjusted to assure minimal limiting of the GPS, WWAN, display, and audio components of the mobile device, while enabling limiting of WLAN, GPU, and camera functions. As another illustration, when a processor executing the user experience software detects or is informed that a video/data call app has been loaded by the user at a certain time of day, a processor executing the user experience software may adjust a policy to assure minimal limiting of the camera, display, modem, WLAN, and audio components. In such a case, the policy may further be adjusted to increase priority for the data subscription in a multi-subscription environment (e.g., dual subscription, dual active or “DSDA”). Various other illustrative use cases may include executing 3D gaming apps (e.g., prioritize GPU, etc.), a Wi-Fi display (e.g., delimit battery access of other transceivers, etc.), web surfing actions, phone calls, music players, etc.

In an aspect, current activity information may be associated with numerous circumstances. In other words, certain activities may define a current circumstance when combined, but also may individually be associated with different circumstances (or use cases). For example, a processor executing the user experience software may identify that a particular foreground application in combination with the current location (e.g., GPS coordinates) of the mobile device correspond to a first predefined circumstance, and that the particular active application alone may also correspond to a second predefined circumstance. In such a case, a processor executing the user experience software may determine a priority or importance for concurrent circumstances. Such a circumstance priority may be based on user preference, manufacturer/developer settings, stored historical data (e.g., aggregated usage data stored in a database), and/or relevance to hardware usage (e.g., battery use, processor use, etc.). Circumstance priorities may be indicated within a database or other stored data that describes the priorities of the predefined circumstances of the mobile device. For example, when first and second circumstances are present, a processor executing the user experience software may perform a look-up to determine which circumstance has a higher priority.

In another aspect, circumstances based on activity information may be detected and acted upon together, that is a processor executing the user experience software may acknowledge or use all current circumstances simultaneously. In this way, a processor executing the user experience software may determine mitigation and other operating policies in a combinatory manner. For example, a processor executing the user experience software may determine multiple predefined circumstances are present based on user inputs on a touchscreen and sensor data. In such a case, a processor executing the user experience software may generate operating policies that encompass information from the activity profiles of all or a combination of the concurrent circumstances. For example, activity profiles of both a first and second current circumstance may be indicate both these circumstances historically use a large amount of battery power, and so a processor executing the user experience software may generate an operating policy that adjusts the operating parameters of device components to accommodate both circumstances.

In various aspects, a processor executing the user experience software may also gather, aggregate, or otherwise collect usage data from numerous sources to generate and/or update the activity profiles of the mobile device. In this way, an activity profile stored in a database and related to a particular app may include hardware usage data updated over the operational life of the mobile device. In particular, a processor executing the user experience software may utilize data provided by developers of apps executing on the mobile device. In an aspect, a processor executing the user experience software may utilize data related to app permissions (e.g., end user permissions upon installation of the app on an Android® smartphone, etc.) to predict likely hardware/resources usage associated with particular apps. For example, when an installed app is related to permissions for location services, a processor executing the user experience software may predict the app may use a GPS chip.

In another aspect, a processor executing the user experience software may utilize API data provided by app developers that indicates likely and/or required hardware usage of an app when it is executing. Via the HLOS, API commands, data, or request messages may be received by a processor executing the user experience software from applications executing on the mobile device. Such API information may indicate particular hardware that the applications request for use. For example, app developers may configure their apps to use an API related to a processor executing the user experience software to indicate that high-priority hardware blocks are typically used by the apps. Based on received API information, a processor executing the user experience software may create and adjust activity profiles that include particular apps.

A processor executing the user experience software may also utilize dynamic resource usage data collected during normal operations of the mobile device. The user experience may continually and/or periodically record usage data occurring during the existence of particular circumstances (e.g., certain applications are executing on the mobile device). The usage data may include information about the resources/hardware components that are presently being used by the mobile device. For example, a processor executing the user experience software may be configured to store in a database codes for all firmware notifications transmitted while a particular social networking app was executing on the mobile device.

Collected usage data from device components may be aggregated or otherwise summarized over time, such as by incorporating newly gathered usage data into histograms for particular activity profiles. A processor executing the user experience software may aggregate usage data in response to various inputs, messages, signals, and other information transmitted by the various components of the mobile device. For example, activity profiles may be appended to or created by a processor executing the user experience software based on data from hardware components (or controllers), the HLOS, software routines, and/or firmware. In various aspects, a processor executing the user experience software may gather and aggregate usage data based on signals such as new current requests to a power controller, messages from devices drivers (e.g., an application has invoked a hardware device, etc.), software system performance monitors, digital power meters (or DPMs), thermal events, and indications from other background monitoring apps. For example, usage data may be aggregated based on signals with client identifiers (e.g., client IDs) associated with requests for hardware power and/or DPM readings that indicate when power budgets are close to a maximum threshold. As another example, other signals may indicate increases in device temperatures that represent hardware block usage. Other gathered data may include monitoring notifications related to the touch rate of a display, network traffic, video rates, encoding rates, call managers, HLOS resource utilization, backlight states, etc.

In various aspects, a processor executing the user experience software may utilize any combination of the above described techniques for generating/updating activity profiles. For example, a processor executing the user experience software may determine hardware usage data for a particular set of executing applications based on API commands and firmware notifications. In an aspect, a processor executing the user experience software may utilize an aggregator module/routine/component that combines, translates, formats, and otherwise aggregates data from various components within the device to determine the hardware that is used/not used and to generate/update activity profiles.

In an aspect, a processor executing the user experience software may continually generate and update activity profiles during the lifecycle of the mobile device (i.e., continuous learning). However, in other aspects, a processor executing the user experience software may diminish or even discontinue gathering usage data based on the frequency of occurrence of particular activity profiles. For example, an activity profile associated with a rarely-encountered circumstance (e.g., a certain set of running applications) may not be aggressively updated by the user experience software; however, an unknown activity profile associated with a new set of active applications may require a higher rate of sampling of hardware usage readings and frequent updates.

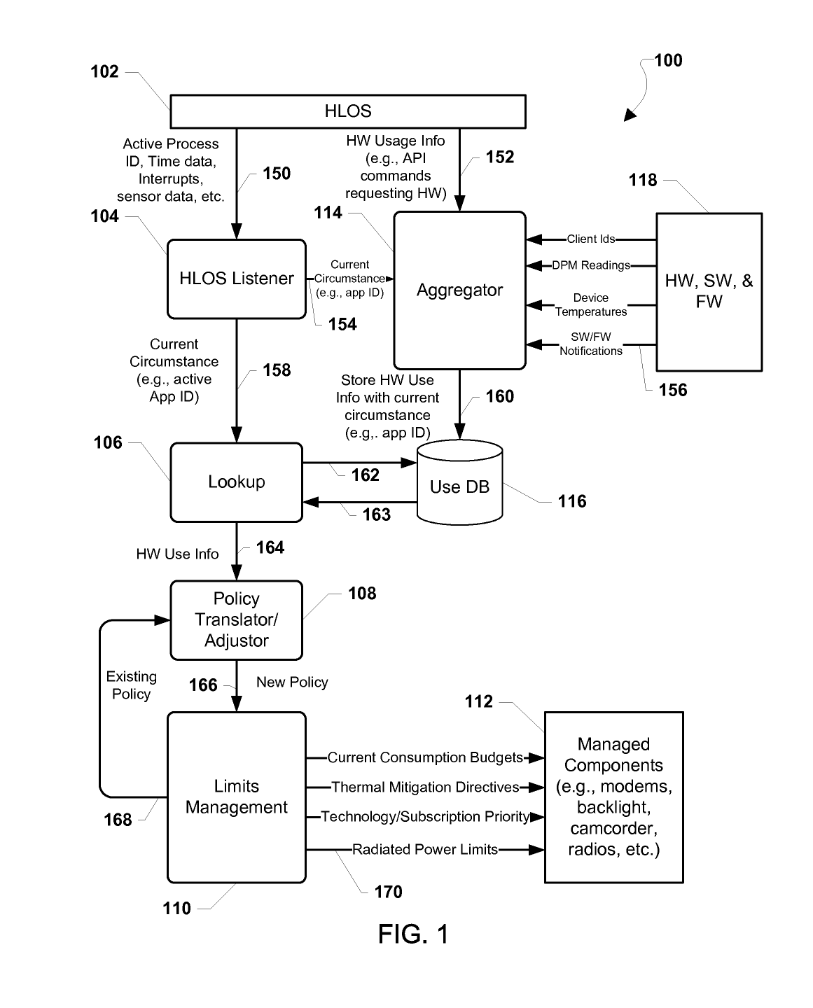

FIG. 1 illustrates example components of an aspect user experience software system 100 implemented in a mobile device. The system 100 may include the high-level operating system (or HLOS) 102 of the mobile device, such as iOS® or Android® operating systems. The HLOS 102 may be configured to transmit signals 150 to an HLOS listener component 104. The signals 150 may include information indicating detected sensor data (e.g., accelerometer sensor data, GPS sensor data, gyroscope sensor data, etc.), data stored within HLOS tables (e.g., coordinates, etc.), time indicators (e.g., time of day, day of week, etc.), active apps or processes (e.g., process identifiers), and messaging information related to active apps or processes (e.g., notifications, interrupts, etc.).

The HLOS listener component 104 may be processes, instructions, routines, software, or operations that monitor for activity information as indicated in the signals 150. For example, the HLOS listener component 104 may monitor in user space for information that indicates the applications (or apps) that are active and/or executing in the foreground of the HLOS. In an aspect, the HLOS listener component 104 may perform operations to identify predefined circumstances based on received activity information. For example, the HLOS listener component 104 may identify a code that represents a circumstance matching the current time of day and/or app ID executing in the foreground of the mobile device. In an aspect, the HLOS listener component 104 may perform operations to translate process identifiers (or process IDs) into application IDs (or app IDs). For example, the HLOS listener component 104 may receive a HLOS message that indicates a certain process identifier is active on the mobile device, and in response may identify the unique application code or name associated with the process identifier. In various aspects, as it may utilize operating system codes and/or messaging, the HLOS listener component 104 may be uniquely or specifically designed for particular operating systems (e.g., iOS®, Android®, etc.).

The HLOS 102 may also transmit signals 152 that indicate hardware or other resource usage information, such as the memory or processor cycles used for a period by a particular app. The signals 142 may be transmitted to an aggregator component 114 that may be processes, instructions, routines, software, or operations for gathering and combining resource usage information. In an aspect, the signals 152 may include API commands that request particular resources, such as hardware blocks, processor cycles, or other components (e.g., microphone, camera, sensors, etc.). The aggregator component 114 may also receive signals 156 from hardware, software and/or firmware components 118 in the mobile device. These signals 156 may include various resource usage information, such as identifiers of hardware blocks that request power during a particular operation (or executing app), digital power meter readings that may indicate heavy usage of hardware (e.g., status of power consumptions budgets for particular hardware), and/or device temperature readings (e.g., a processor temperature increases quickly during the execution of a particular app, etc.). The signals 156 may also include notifications from software and/or firmware, such as device driver notifications that indicate when certain drivers are invoked by executing applications and/or notifications related to touch rate monitors, network traffic monitors, video rates, encoding rates, call managers, backlight state monitors, and HLOS resource utilization monitors.

The HLOS listener component 104 may be configured to transmit signals 154 to the aggregator component 114 that indicate current circumstances based on activity information. For example, the signals 154 may indicate an app ID, a time of day, or any other code associated with a predefined circumstance known to the user experience software. The aggregator component 114 may be configured to combine, translate, format, and/or otherwise process the various usage information and circumstance information it receives. For example, the aggregator component 114 may average, normalize, and/or prioritize hardware usage information provided by the HLOS 102 and the hardware, software, and firmware components 118. The aggregator component 114 may associate received circumstance information received from the HLOS listener component 104 with usage information received from the HLOS 102 and/or the hardware, software and/or firmware components 118.

The aggregator component 114 may transmit signals 160 to a use database 116 for storing aggregated resource usage information. In particular, the signals 160 may indicate a circumstance (or circumstance codes/identifiers) and its associated resource usage information (e.g., device temperatures, etc.). For example, the aggregator component 114 may transmit signals 160 that indicate an app ID executing on a processor and associated thermal threshold values. The use database 116 may store the information received in the signals 160. In particular, the use database 116 may store activity profiles that include resource usage information in relation to circumstances. For example, the use database 116 may store numerous usage data, such as aggregated memory use and average device temperatures, in relation to an app ID.

The HLOS listener component 104 may also transmit signals 158 indicating identified circumstances (e.g., app ID of the application executing in the foreground) to a lookup component 106. The lookup component 106 may be processes, instructions, routines, software, or operations that interface with the use database 116 and retrieve resource usage information related to current circumstances. In particular, the lookup component 106 may transmit signals 162 indicating current circumstances to the use database 116 and may receive response signals 163 that indicate resource usage information stored in relation to the circumstances. In various aspects, the response signals 163 may also include threshold values, rules, conditions, and other stored information related to the current circumstances.

The lookup component 106 may transmit retrieved usage information to a policy translator/adjustor component 108. The policy translator/adjustor component 108 may be processes, instructions, routines, software, or operations that identify operating policies to implement based on current resource or hardware use information. Such operating policies may include rules sets and other parameters for mitigating units and processes within the mobile device. For example, the operating policies may reprioritize existing mitigation priorities with new information about hardware usage. The policy translator/adjustor component 108 may transmit signals 166 including new operating policies to a limits management component 110, which may be processes, instructions, routines, software, or operations for controlling the various components, subsystems, and operations within the mobile device. In other words, limits management software may be informed by the operating policies generated by the policy translator/adjustor component 108. In an aspect, the limits management component 110 may transmit signals 168 that include an existing policy to the policy translator/adjustor component 108, which in turn may adjust that existing policy based on current resource usage information.

With an implemented operating policy (or new policy), the limits management component 110 may transmit signals 170 to managed components 112 that indicate various instructions, commands, or requests for mitigating the mobile device based on the user's current activities (i.e., the current circumstances). For example, the signals 170 may include information indicating consumption budgets, thermal mitigation directives, priorities for subscriptions/technologies, and/or radiated power limits. In various aspects, the managed components 112 may include modems, backlights, cameras, camcorders, microphones, transceivers/radios (e.g., WiFi, Bluetooth, WiFiDirect, RF, IR, etc.), sensors, routines, and any other element of the mobile device that has adjustable operating parameters and/or can be configured to operate based on the user's current activities.

In various aspects, the functionalities of the various components 104, 114, 106, 116, 108, 168 described above may be combined or divided among various modules, software, components, and other units to enable user software experience. For example, an aspect user experience software may include a module for executing all of the operations described above with reference to the HLOS listener component 104, aggregator component 114, lookup component 106, policy translator/adjustor component 108, and limits management component 110.

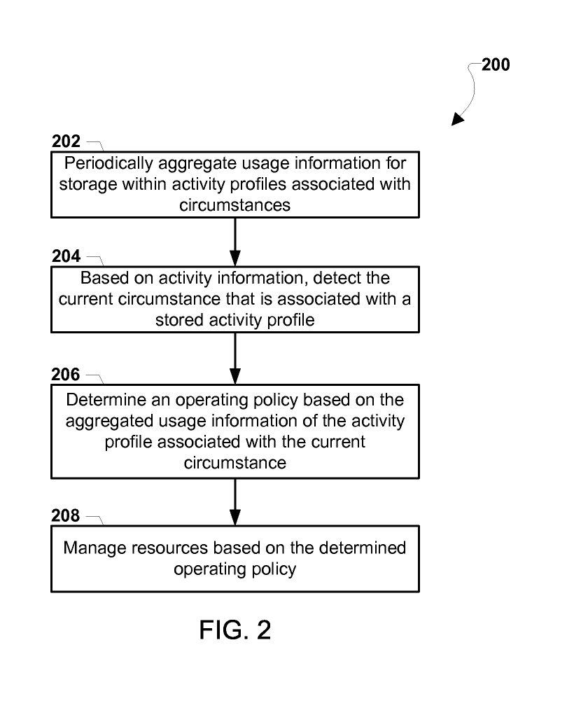

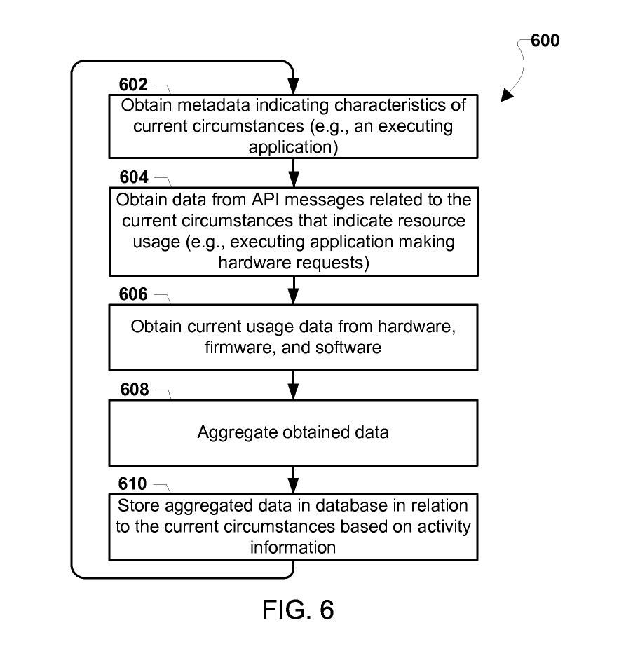

FIG. 2 illustrates an aspect method 200 for a user experience software executing on a mobile device to implement an operating policy based on a user's activity. In block 202, a processor executing the user experience software may periodically aggregate usage information for storage within activity profiles associated with circumstances. For example, every period (e.g., millisecond(s), second(s), etc.), the processor may update a database of activity profiles to reflect current hardware and other resource usage in relation to circumstances, such as executing applications, time (e.g., time of day, day of week), and sensor data. In various aspects, the usage information may include data from API messages, as described below. For example, API messages that indicate preferred, likely needed, or otherwise requested device resources may be transmitted by applications executing on the computing device and may be received by the processor or aggregating with other usage information. In an aspect, the operations in block 202 may be performed by an aggregator component as described above. In an aspect, the operations of block 202 may include the operations of the method 600 described below with reference to FIG. 6.

In various aspects, the period at which the processor executing the user experience software may update a database of activity profiles may be fixed or variable. For example, the processor may increase or decrease the periodicity or frequency at which usage information is obtained and aggregated based on factors such as available battery power, a time of day, current usage of the device resources, and other factors. In another aspect, the processor may aggregate usage information (and update associated activity profiles) in response to receiving interrupts (e.g., a period for aggregation may be determined by the receipt of autonomous interrupts or other messages). In other words, the arrival of resource usage information may cause the processor executing the user experience software to aggregate the usage information. For example, the processor may receive and respond to the autonomous delivery of usage information via system component (e.g., controller) interrupts.

In block 204, based on activity information, such as user inputs initiating an app on the mobile device, the processor may detect the current circumstance that is associated with a stored activity profile. As described below, the current circumstance may be predefined and may be used to look-up relevant resource usage information stored in a relational database. In an aspect, the operations in block 204 may be performed by a HLOS listener and lookup components as described above. In various aspects, the processor may update and/or adjust the activity profiles in response to identifying the current activity information. For example, the processor may aggregate usage information in response to receiving autonomous interrupts that indicate current activity information and may also update, modify, and/or adjust threshold values associated with activity profiles based on the current activity information.

In block 206, the processor may determine an operating policy based on the aggregated usage information of the activity profile associated with the current circumstance. As described below, the processor may interpret usage information relevant to the current circumstance and determine the best way for the mobile device and its various components to maintain a convenient experience for the user given the user's activities. In an aspect, the operations in block 206 may be performed by a policy translator/adjustor component as described above.

In block 208, the processor may manage (or cause another processor to manage) resources based on the determined operating policy. For example, the processor may direct a limits management component to transmit new operating parameters to units, such as modems or an LCD display, indicating that less power is allowed to be consumed for a period of time. In an aspect, the operations in block 208 may be performed by a limits management component as described above.

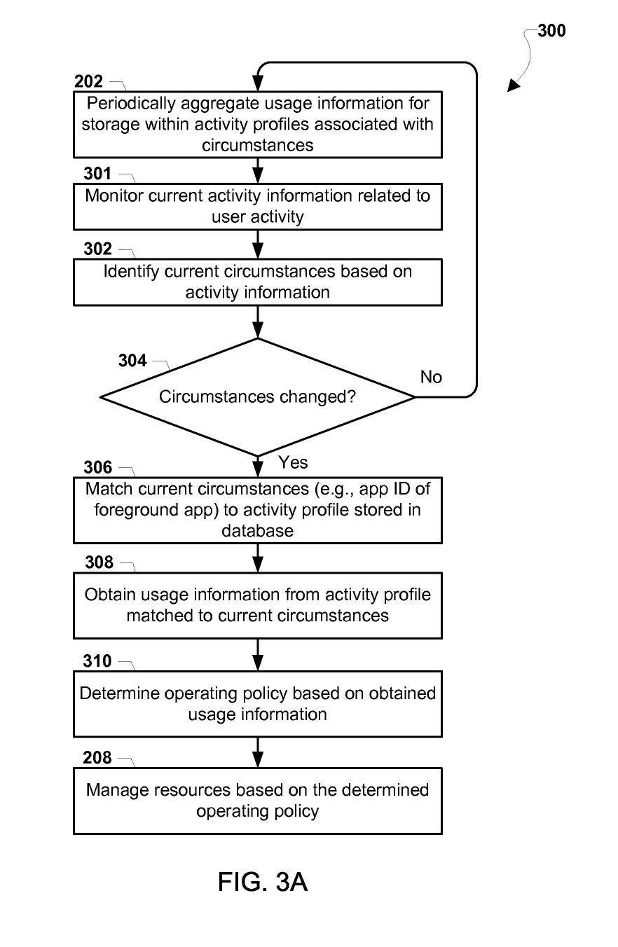

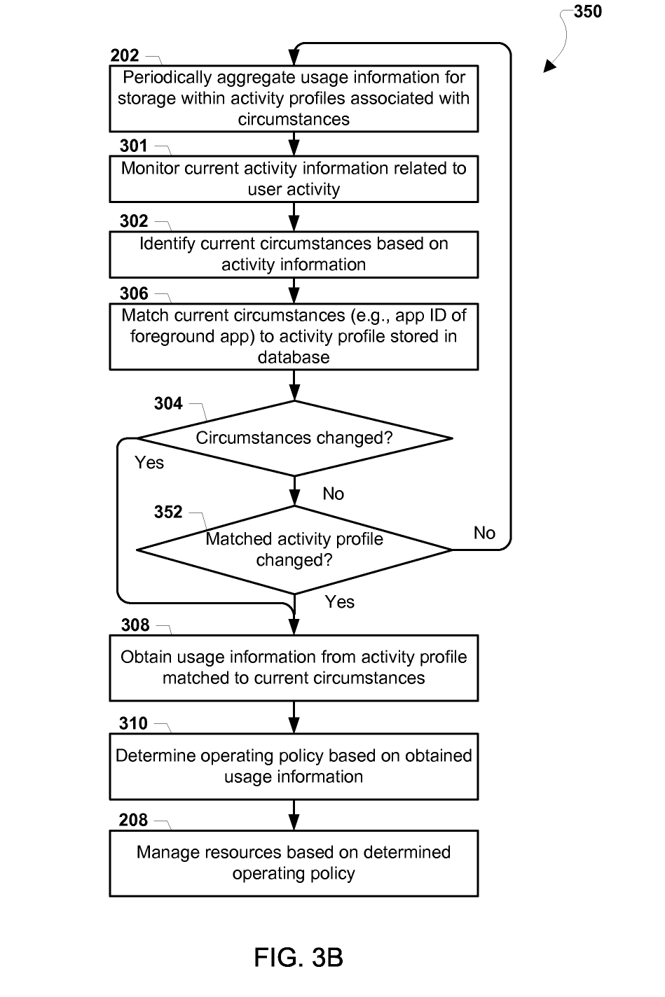

FIG. 3A illustrates an aspect method 300 for a user experience software executing on a mobile device to implement an operating policy based on a user's activity. The method 300 is similar to the method 200 described above, except the method 300 includes additional, more detailed operations for an aspect mobile device determining operating policies based on a user's activities.

In block 202, a processor executing the user experience software may periodically aggregate usage information for storage within activity profiles associated with circumstances. In block 301, the processor may monitor current activity information related to user activity. For example, the processor may monitor messages from the HLOS of the mobile device that indicate the current app executing at the foreground, sensor data (e.g., accelerometer data, GPS data, etc.), detected user inputs, various interrupts, and/or states of the operating system (e.g., shut-down, sleep mode, configuration mode, etc.). In an aspect, the current activity information may indicate whether user input data (e.g., a touch on a touchscreen) that is associated with the selection of a new app to execute as a foreground app. In an aspect, the processor may monitor for current activity information at certain periods that may be static or alternatively variable, such as described above with reference to the operations in block 202 in FIG. 2. In various aspects, monitoring for current activity may include monitoring for interrupts from components, modules, routines, or units within the mobile device. In block 302, the processor may identify the current circumstances based on the activity information. For example, the processor may match the current activity information (e.g., active applications, time of day, logged in user credentials, location information, etc.) to predefined circumstances (or use cases). The processor may be configured to store the identified circumstances (or a representative code or identifier of the circumstances) in a variable for later comparisons. In an aspect, the app ID of the application executing in the foreground may define the current circumstance. In an aspect, the operations in blocks 301-302 may be performed by an HLOS listener component as described above.

In determination block 304, the processor may determine whether circumstances have changed. In other words, the processor may compare the identified current circumstances to previously identified circumstances to detect when a new or current circumstance is different from an old or previously-detected circumstance. In an aspect, the determination may be performed using a comparison of a code or identifier of the current circumstances with a stored code or identifier of the last identified circumstances. If the circumstances have not changed (i.e., determination block 304=“No”), the processor may continue with the operations in block 202.

If the circumstances have changed (i.e., determination block 304=“Yes”), in block 306 the processor may match the current circumstances to an activity profile stored in a database. For example, a processor executing the user experience software may match a code representing a current circumstance (e.g., app ID of the application currently executing in the foreground of the mobile device) to a code associated with a record stored in the database. In an aspect, the processor executing the user experience software may use the circumstances to perform a look-up on a relational database that includes activity profiles as described above. In an aspect, the operations in block 306 may be performed by a look-up component as described above. In an aspect, a plurality of applications may be executing in the foreground of the mobile device, and thus the processor may identify an active application (or app) within the plurality of applications executing in the foreground. In other words, the current circumstance may be the app ID of an application that is both executing in the foreground of the mobile device and active (e.g., being interfaced with by a user) at a given time. In block 308, the processor may obtain usage information from the activity profile matched to the current circumstances. In particular, the processor may retrieve stored, aggregate resource (or hardware) usage data, such as historical memory use and/or graphical processing unit (GPU) temperatures associated with the current circumstances.

In block 310, the processor executing the user experience software may determine an operating policy based on the obtained usage information. The processor may assess, evaluate, and otherwise interpret the obtained usage information to generate the operating policy. For example, based on obtained usage information that indicates a high amount of transmission/antennae interference (e.g., desense) with the current circumstances of concurrent subscriptions, a processor executing the user experience software executing on a dual SIM dual active (DSDA) mobile device may determine an operating policy that prioritizes one subscription over another (e.g., perform blanking on the low priority subscription for a period). As another example, the processor may determine that a currently implemented operating policy may result in thermal temperatures that exceed a tolerance threshold (e.g., achieve a critical temperature), and thus may determine a new operating policy that decreases the frequency at which a routine is executing related to a WiFi transceiver. In an aspect, the processor may utilize a policy translator/adjustor component to perform the operations in block 310 as described above. In block 208, the processor may manage resources based on the determined operating policy.

FIG. 3B illustrates an aspect method 350 for a user experience software executing on a mobile device to implement an operating policy based on a user's activity. The method 350 is similar to method 300 described above, except that method 350 may include operations to determine a new operating policy when activity profiles change. As described above, the various aspects utilize dynamic information about resource usage to tailor operating policies. In certain cases, current circumstances (e.g., what applications are executing on the mobile device, inputs received from the user, time period, etc.) may not change, but operating policies may still need to be adjusted. For example, over time, a processor executing the user experience software may periodically gather usage information from hardware, software, and firmware (e.g., power meter data, hardware block requests, etc.), and based on aggregations or averaging of that data, related operating policies may evolve. In particular, as data sets that are encountered become larger, aggregation operations by the processor may remove outlier usage data, thereby causing changes to prescribed operating policies for similar circumstances. Therefore, additional operations for detecting whether stored activity profiles change may also be performed to determine operating policies.

In block 202, a processor executing the user experience software may periodically aggregate usage information for storage within activity profiles associated with circumstances. In block 301, the processor may monitor current activity information related to user activity. In block 302, the processor may identify the current circumstances based on the activity information. In block 306 the processor may match the current circumstances to an activity profile stored in a database.

In determination block 304, the processor may determine whether circumstances have changed. If the circumstances have not changed (i.e., determination block 304=“No”), the processor may determine whether the matched activity profile has changed in determination block 352. In other words, even when the user's activity or interaction with the mobile device has not changed, the operating policy for mitigation may need to be adjusted, updated, or otherwise changed in order to account for periodic updates to the activity profiles, as described below with reference to method 600. In an aspect, the processor may determine activity profile changes by using a stored flag, variable, or other indicator within the activity profile that indicates whether updates, new usage data, or other adjustments have been made to the activity profile since the last time it was accessed by the processor with reference to performing the method 350 (or method 300).

If the matched activity profile has not changed (i.e., determination block 352=“No”), the processor may continue with the operations in block 202. However, if the matched activity profile has changed (i.e., determination block 352=“Yes”), or if the circumstances have changed (i.e., determination block 304=“Yes”), in block 308 the processor may obtain usage information from the activity profile matched to the current circumstances. In block 310, the processor may determine an operating policy based on the obtained usage information. In block 208, the processor may manage resources based on the determined operating policy. In various aspects, the method 350 may be performed in place of the method 300.

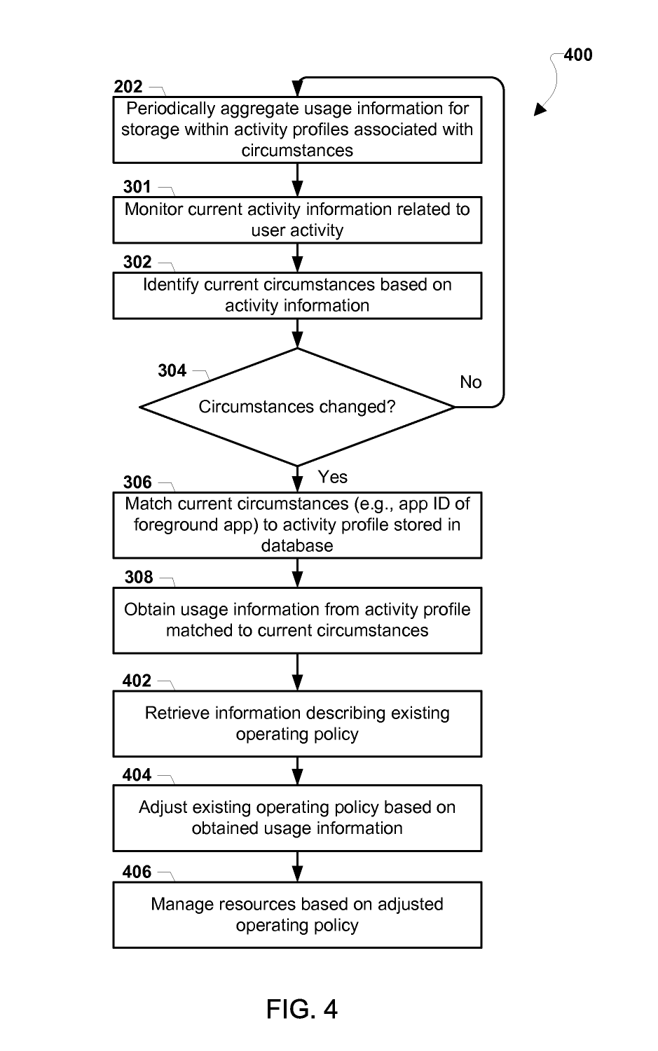

FIG. 4 illustrates an aspect method 400 for a user experience software executing on a mobile device to implement an operating policy based on a user's activity. The method 400 is similar to the methods described above, except that the method 400 may include operations for adjusting a previously-implemented operating policy. For example, in response to determining a new circumstance exists in which the mobile device is likely to operate above prescribed thermal thresholds, a processor executing the user experience software may adjust the current operating policy by decreasing the periodicity of regular operations to promote less processing and thus a lower device temperature.

In block 202, a processor executing the user experience software may periodically aggregate usage information for storage within activity profiles associated with circumstances. In block 301, the processor may monitor current activity information related to user activity. For example, the processor may receive a notification (e.g., a notification that is independent of the HLOS of the mobile device) that indicates the device's battery has little charge remaining. In block 302, the processor may identify the current circumstances based on the activity information. For example, the processor may match the current activity information of an active GPS chip and a low battery charge to a known, predefined circumstance. In determination block 304, the processor may determine whether circumstances have changed. In an aspect, the operations in determination block 304 may be optional when the processor is configured to periodically perform operations regarding operating policies. If the circumstances have not changed (i.e., determination block 304=“No”), the processor may continue with the operations in block 202.

If the circumstances have changed (i.e., determination block 304=“Yes”), in block 306 the processor may match the current circumstances to an activity profile stored in a database. In block 308, the processor may obtain usage information from the activity profile matched to the current circumstances. In block 402, the processor may retrieve information describing an existing operating policy. For example, the processor may retrieve a set of active operating directives for mobile device components that is appropriate for normal temperatures for all components. In block 404, the processor may adjust the existing operating policy based on the obtained usage information. For example, the processor may change the thermal mitigation directives of the existing operating policy based on current usage information that indicates the mobile device may generate much more heat in an upcoming time period. As another example, the existing operating policy may be adjusted to permit less processing cycles and/or power consumption for wide area network radios (e.g., WiFi, cellular transceivers, etc.) when the current circumstances correspond to a computationally intensive application executing in the foreground with little remaining battery power.

In block 406, the processor may manage resources based on the adjusted operating policy. For example, the mobile device may be configured to manage system operations in order to utilize less battery power, perform fewer or less frequent operations that result in device heat increases, and/or deactivate components (e.g., a camcorder).

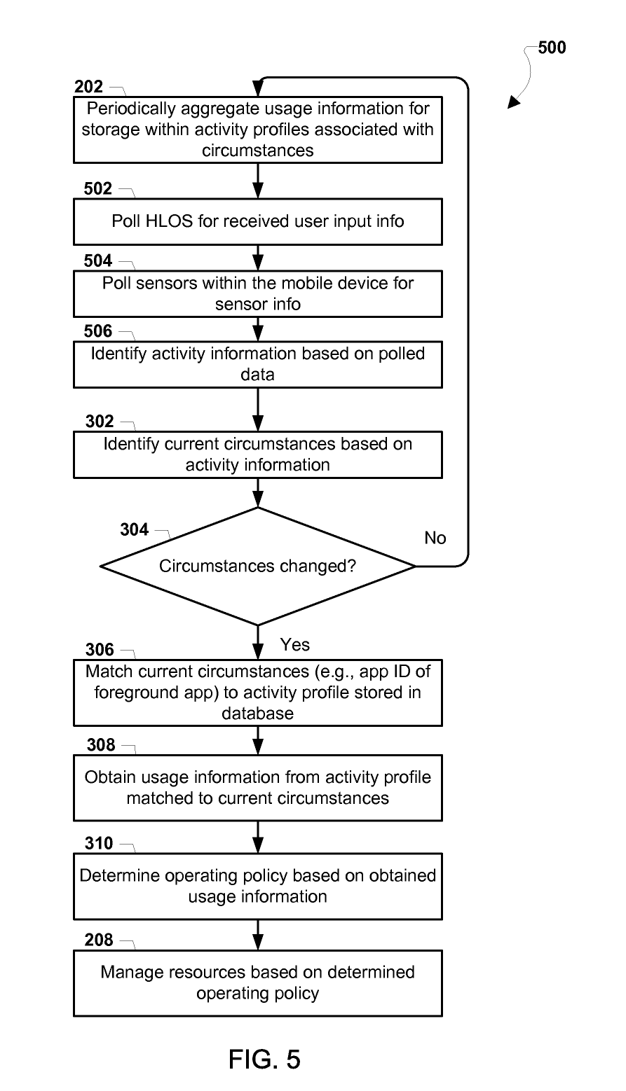

FIG. 5 illustrates an aspect method 500 for a user experience software executing on a mobile device to implement an operating policy based on a user's activity. The method 500 is similar to the methods described above, except that the method 500 may include operations for polling components in the mobile device to receive activity information. By polling components of the mobile device (or receiving data from the HLOS describing the status of the components), a processor executing the user experience software may identify circumstances that are directly affected by the actions of the mobile device user. For example, by detecting whether accelerometer data that indicates motion exists, a processor executing the user experience software may identify that the user is jogging and thus may determine an operating policy that prioritizes a music app over other operations.

In block 202, a processor executing the user experience software may periodically aggregate usage information for storage within activity profiles associated with circumstances. In block 502, the processor may poll the HLOS for received user input information. In particular, the processor may poll the HLOS to determine whether the user has entered any input, such as typing data, hard or soft button presses, or finger swipes on a touchscreen. Such input data may be used by the processor to identify whether and how the user is actively using the mobile device. Input data from the HLOS may also include identifying information for applications, such as process identifiers, or selected icon names. For example, the processor may receive the name of the graphical icon pressed by the user via the touchscreen.

In block 504, the processor may poll sensors within the mobile device for sensor information. For example, pressure sensors, accelerometers, GPS sensors, microphones, cameras, and other sensors may be polled to determine whether the user is actively moving or otherwise engaged in a physical interaction with the mobile device.

In block 506, the processor may identify activity information based on the polled data. For example, based on a received accelerometer sensor data sample, the processor may determine whether motion data does or does not indicate the user is jumping, running, or otherwise moving erratically. In an aspect, the processor executing the user experience software may evaluate the polled data to remove errors, outliers, and other data that may not accurately represent the current state of the user's interaction and/or activity in general. For example, the processor may be configured to normalize or average sensor data for a sampling period or alternatively remove the highest and lowest values in a sampled data set. In an aspect, the processor executing the user experience software may use data received from the HLOS to determine applications that are initiated by user inputs. For example, the processor may identify applications that have been launched based on interrupts, signals, or other messages that are reported by the HLOS that also include descriptive information (e.g., a signal may indicate that a touch input was detected that coincides with an “Application B” graphical icon).

In block 302, the processor may identify the current circumstances based on the activity information. In determination block 304, the processor may determine whether circumstances have changed. If the circumstances have not changed (i.e., determination block 304=“No”), the processor may continue with the operations in block 201. If the circumstances have changed (i.e., determination block 304=“Yes”), in block 306 the processor may match the current circumstances to an activity profile stored in a database. In block 308, the processor may obtain usage information from the activity profile matched to the current circumstances. In block 310, the processor may determine an operating policy based on the obtained usage information. In block 208, the processor may manage resources based on the determined operating policy.

FIG. 6 illustrates an aspect method 600 for a mobile device processor executing user experience software to aggregate and store data for use in determining operating policies based on a user's activity. As described above, a processor executing the user experience software may gather data from various sources, such as resource usage information reported by devices and API requests by applications executing on the mobile device. With the various data, the processor executing the user experience software may perform operations to combine, format, correct, filter, and otherwise transform the data for use in activity profiles. The processor may perform the operations of the method 600 periodically such that the user experience software is dynamically updated. For example, over a period of executing a particular application, a processor executing the user experience software may regularly perform the operations of the method 600 to generate more accurate usage information describing the hardware block use of that application. In an aspect, the operations of the method 600 may be performed by an aggregator component executing on the processor as described above. In another aspect, the mobile device may perform the operations of method 600 in place of the operations of block 202 described above. For example, the method 600 may be performed to update activity profiles in a database in conjunction with other operations for determining an operating policy to implement for managing resources based on a touchscreen input.

In block 602, a processor executing the user experience software may obtain metadata indicating characteristics of current circumstances, such as metadata for an application executing in the foreground. In particular, the processor may obtain stored data configuration, initialization, or other basic descriptive data about applications and may translate that information into predications of resource consumption. For example, upon download and installation of an app from an app store (e.g., Google Play, iTunes, etc.), the mobile device may receive and store metadata that indicates the likely hardware and/or services utilized by the app. In an aspect, the processor executing the user experience software may obtain, infer, or otherwise predict the resources that may be used by a particular application based on permissions data (or configuration data) associated with the application. In other words, the processor may predict resources that are relevant to the current circumstances based on information provided by an app developer. For example, based on end user notices associated with a downloaded app that indicate that app provides location services, the processor may determine the app likely utilizes a GPS chip, data plan usage, and a moderate amount of processing/battery power.

In block 604, the processor may obtain data from application programming interface (API) messages related to the current circumstances that indicate resource usage. In an aspect, the processor may support an API that exposes commands to applications. Such API messages may include data, requests, commands, or other information that indicates likely and/or required resource usage related to current circumstances (e.g., an executing application). For example, API message may include requests for resources, such as requests to allocate or access particular hardware, components, data plan use, processing cycles, and other capabilities of the mobile device. As another example, the processor may receive an API command from the executing application via the HLOS that indicates the application requests to use a certain hardware or IP block. Although such API messages may not be accurate indicia of actual resources used by the application (e.g., developers may configure applications to request more resources than needed), the API messages may provide valuable information that may indicate the manner, intended use, and likely resource consumption of the application.

In an aspect, the processor may identify when API messages request resources or otherwise may cause unwanted operating conditions. For example, the processor may determine that a particular API message from a certain app requests too many resources (e.g., multiple cores) or, alternatively, requests resources that may cause a dangerous or suboptimal operating policy given the current circumstances of the device (e.g., temperature). In such a case, the processor may void, ignore, or weight the API messages so that the potentially negative effects of its requests or other data may be avoided.

In block 606, the processor may obtain current usage data from hardware, firmware, and software. The processor may gather messages (e.g., interrupts and other signals from hardware, software, firmware, and other components within the mobile device) that indicate how and when resources are allocated while the current circumstances exist. This gathered resource usage information may be stored over time to provide the historical resource use during certain circumstances (e.g., a particular app is executing in the foreground). Examples of usage data reported by hardware, firmware, and software may include hardware requests for power, hardware block availability/use, power meter readings, temperatures of various components/devices, device driver notifications, and various component or resources monitors (e.g., video rate monitor, encoding monitor, etc.). In general, when gathered current usage data indicates a component (e.g., GPU, memory, etc.) is experiencing more frequent requests for power or higher temperatures, the processor may associate the component's use with the circumstances at that time.

In block 608, the processor may aggregate the obtained data. In other words, the processor may combine the various types of obtained data to identify trends, averages, and general resource usage characteristics. In various aspects, the processor may place different weights or emphasis on different sources of data. For example, as gathered firmware usage data may not be as speculative as metadata provided by an application developer, the gathered firmware usage data may be prioritized by the user experience software. In various aspects, the processor may utilize any combination of the obtained data when aggregating usage data. In an aspect, the aggregation may be performed based on predetermined rules sets, logic, and analysis parameters, such as designed by the user of the mobile device, a manufacturer, and/or a developer.

In block 610, the processor may store the aggregated data in a database in relation to the current circumstances based on activity information. As described above, the processor may store the aggregated data in an activity profile associated with circumstances that are determined based on activity information, such as the identity of the app executing in the foreground, time of day, and sensor data. In an aspect, the processor may perform a look-up in a relational database using the circumstances, and update the associated usage information stored in the database using the aggregated data. For example, the processor may amend, average, correct, or otherwise change the usage data stored in relation to an activity profile using the current aggregated data. In an aspect, when the database does not already include an activity profile associated with the determined circumstances, the may be configured to create a new activity profile using the determined circumstances and the aggregated data. The processor executing the method 600 may then continue with the operations in block 602.

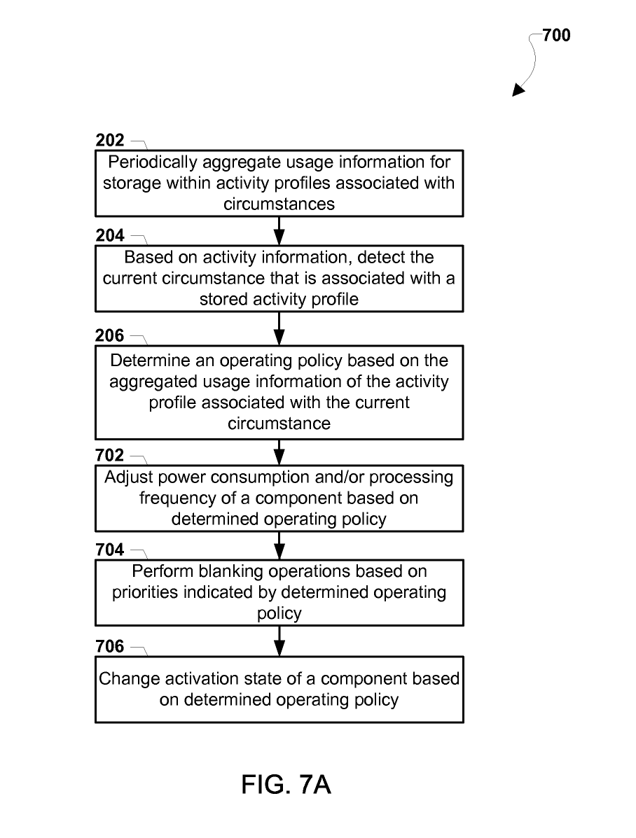

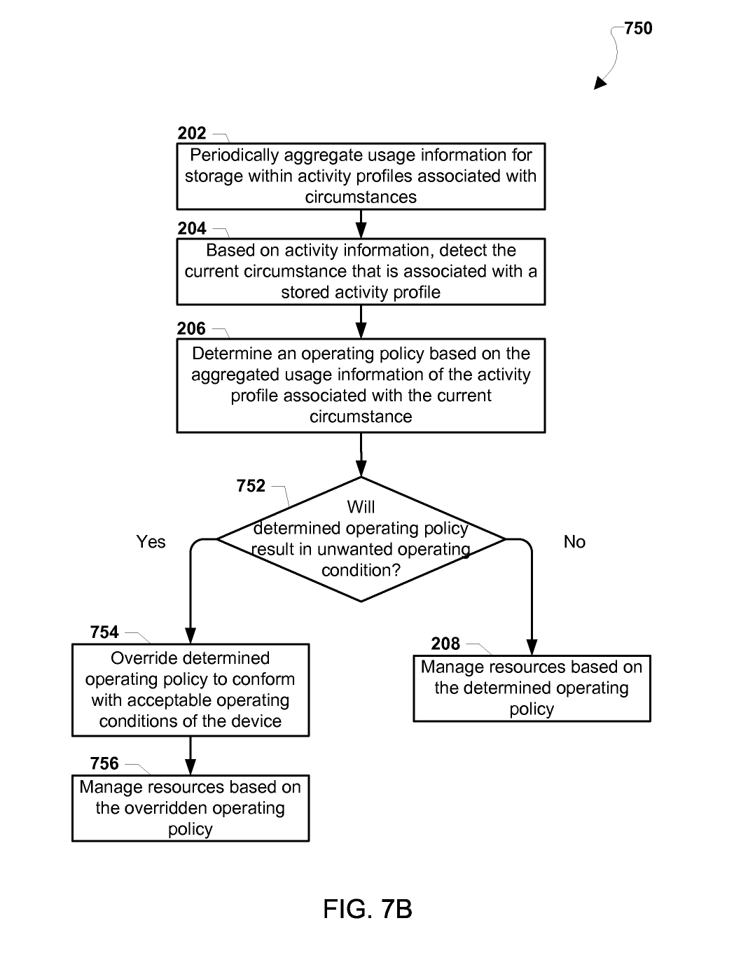

FIG. 7A illustrates an aspect method 700 for a user experience software executing on a mobile device to implement various resource management operations of an operating policy. As described above, determined operating policies may be used by a processor executing the user experience software to configure, control, or otherwise manage the various components and resources of the mobile device given current circumstances. For example, when several subscriptions or technologies are concurrently active (e.g., concurrent data calls in a DSDA device), the operating policy may prioritize one subscription over the other and cause blanking operations to be performed on the lower priority subscription. In various aspects, the resources of the mobile device may be managed using a combination of actions, routines, budgets, thresholds, and commands appropriate for the particular components and/or activities of the mobile device. Thus, the management operations described below are merely illustrative and not exhaustive of the management operations that may be implemented based on an operating policy.

As described above, in block 202, a processor executing the user experience software may periodically aggregate usage information for storage within activity profiles associated with circumstances. In block 204, based on activity information, such as user inputs initiating an app on the mobile device, the processor may detect the current circumstance that is associated with a stored activity profile. In block 206, the processor may determine an operating policy based on the aggregated usage information of the activity profile associated with the current circumstance.

As described above, the resources, actions, and operating characteristics of the mobile device may be mitigated or otherwise adjusted based on the determined operating policy. In FIG. 7 blocks 702-706 illustrate exemplary operations for mitigating and changing mobile device behavior, but other mitigation actions may be performed in other aspects. In block 702, the processor may adjust power consumption and/or processing frequency of a component based on the determined operating policy. In other words, the processor may change, deactivate, or activate thresholds, parameters, or rules for operating a component or resource. For example, the processor may configure a subsystem that searches for wide area network access points (e.g., cellular network, WiFi, etc.) to stagger the performance of its operations at long intervals, to forbid the use of antennae or radio components during certain time periods, and/or to suspend operations until further notice. In various aspects, the adjustments to power consumption and/or processing frequency may be increases or decreases based on the priority, importance, or other characteristics as indicated by the determined operating policy. For example, the operating policy may indicate that a WiFi radio may utilize more battery power than typically permitted when the mobile device is identified as running a multi-player, networked video game application. In an aspect, the processor may adjust (or cause another processor to adjust) power consumption and/or processing frequency to affect thermal output by the component (i.e., less heat due to less power or lower frequency of use).

In block 704, the processor may initiate or perform blanking operations based on priorities indicated by the determined operating policy. As described above, in dual subscription, dual active configurations (in which multiple subscription/technologies are utilized by the mobile device), concurrent voice or data calls on the subscriptions/technologies may cause degraded performance. For example, a voice call on a first subscription may experience interference, or desense, due to a simultaneous call on a second subscription. The operating policy may indicate the priority of concurrent subscriptions as well as indicate that blanking operations may be performed to promote higher priority subscriptions. For example, the operating policy may direct a processor executing the user experience software to cause a lower priority call to pause or otherwise be suspended for a period or until the higher priority call has completed.

In block 706, the processor may change (or cause another processor to change) the activation state of a component based on the determined operating policy. In other words, the operating policy may instruct the user experience software to deactivate a module, routine, component, or other unit within the mobile device for a period of time or during the existence of the current circumstance. For example, the operating policy may instruct the processor to deactivate (or cause another processor to change) a camera component when a battery charge state is low and the user is engaged in a voice call. Alternatively, the operating policy may cause the component to be activated.

In various aspects, any or all of the operations of blocks 702-706 may be optionally or selectively performed based on the determined operating policy, the user's activity, component settings, and/or other conditions associated with the operations of the mobile device. For example, when the mobile device is not configured to operate as a DSDA device, and thus there may not be concurrent active subscriptions, the operations in block 704 may not be performed.

FIG. 7B illustrates an aspect method 750 that may be implemented on a mobile device proposal executing user experience software to override or otherwise adjust an operating policy. As described above, determined operating policies may be based on various usage information. In particular, API messages may be used by a processor executing the user experience software to define an operating policy for a certain circumstance. For example, when a certain app is executing on the foreground of the mobile device processor, the processor executing the user experience software may implement an operating policy that manages resources based on API messages transmitted by that certain app (e.g., certain hardware or resources may be reserved for the app). However, as API messages may not be well regulated or may include inaccurate representations of the resource needs/characteristics of related applications (e.g., application developers may configure their apps to transmit API messages to demand resources they do not actually need to function properly), operating policies based on such API messages may result in suboptimal, dangerous, or otherwise improper operating conditions. For example, when the mobile device has a high operating temperature and/or a diminished battery, an operating policy that permits large heat expenditures and/or high power consumption may result in a suboptimal experience for the user (e.g., the battery may die too quickly or the device may overheat). Thus, a processor executing the user experience software may be configured to perform additional checks and make exceptions to determined operating policies in order to ensure API messages do not result in unwanted operating conditions.

As described above, in block 202, a processor executing the user experience software may periodically aggregate usage information for storage within activity profiles associated with circumstances. In block 204, based on activity information, such as user inputs initiating an app on the mobile device, the processor may detect the current circumstance that is associated with a stored activity profile. In block 206, the processor may determine an operating policy based on the aggregated usage information of the activity profile associated with the current circumstance.

In determination block 752, the processor may determine whether the determined operating policy will result in an unwanted operating condition. In other words, the processor may compare the current operating conditions, such as internal temperature, interference on various active subscriptions/technologies, processor activity, available battery power, etc., and predict the effects of implementing the determined operating system under such conditions. For example, based on a high current internal temperature of the mobile device, the processor may predict that the determined operating policy may cause the mobile device to become over-heated. As another example, based on a determined operating policy that may allocate most processing and/or power to a particular module, the processor may predict that voice calls on subscription/technologies may be dropped and/or experience quality of service below an acceptable threshold. As described above, in an aspect, such negative or unwanted operating conditions may occur when API messages are abused (e.g., request inappropriate or unneeded device resources). In an aspect, the processor executing the user experience software may predict SAR values and/or co-existence conditions based on the determined operating policy to determine whether unwanted conditions may result with regards to concurrently active subscriptions/technologies.

If the processor determines that the determined operating policy will not result in an unwanted operating condition (i.e., determination block 752=“No”), in block 208 the processor may manage the resources based on the determined operating policy. However, if the determined operating policy will result in unwanted operating conditions (i.e., determination block 752=“Yes”), in block 754 the processor may override the determined operating policy to conform to acceptable operating conditions of the device. The processor may change the parameters, characteristics, or values of the determined operating policy. For example, when the processor predicts that a heat tolerance threshold will be exceeded with the implementation of the determined operating policy, the processor executing the user experience software may remove (or cause another processor to remove) certain resource allocations or the extent (e.g., frequency of cycling, etc.) to which resources may be used as defined in the determined operating policy to avoid overheating the mobile device. In an aspect, the processor may simply negate, nullify, or ignore parts or all of the determined operating policy. In block 756, the processor may manage the resources based on the overridden operating policy. For example, the processor may maintain the currently in-use operating policy (or a previous operating policy) and ignore the determined operating policy entirely, or alternatively manage resources using the determined operating policy with adjusted parameters that will not cause unwanted operating conditions.

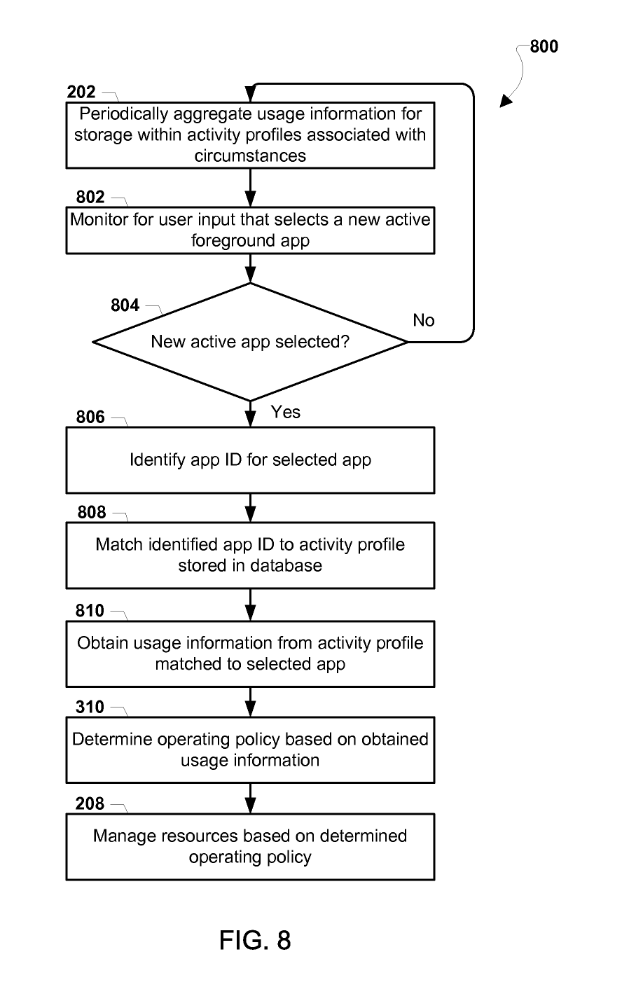

FIG. 8 illustrates an aspect method 800 that may be implemented on a mobile device processor executing a user experience software to implement an operating policy based on an activity profile matched to an application selected for execution in the foreground of the device. The method 800 is similar to the method 300 described above, except that the method 800 addresses a particular circumstance defined by the application executing in the foreground of the mobile device processor. In other words, this aspect method 800 manages resources according to the operating policy that corresponds to whatever application is running in the foreground of the mobile device processor at a given time. For example, when Application A is executing on a processor of the mobile device, a first operating policy may be implemented; however, a second operating policy may be implemented when Application B begins executing in the foreground of the mobile device processor.

In block 202, a processor executing the user experience software may periodically aggregate usage information for storage within activity profiles associated with circumstances. In block 802, the processor may monitor for user input that selects a new active foreground application (or app). For example, the processor may continually or periodically listen for messages from the HLOS (e.g., interrupts, etc.) that correspond to a user touching an app icon on a touchscreen. In an aspect, a plurality of applications (or apps) may be executing on the foreground of the mobile device at a given time, and one of the plurality of apps executing in the foreground may be active (e.g., the active app may be the app a user has begun interfacing with via a touchscreen). In determination block 804, the processor executing the user experience software may determine whether a new active application (or app) is selected. If a new active app is not selected (i.e., determination block 804=“No”), the processor may continue with the operations in block 202.

If a new active app is selected (i.e., determination block 804=“Yes”), the processor may identify an app ID for the selected app. For example, the processor may convert or translate a process identifier provided by the HLOS into an app ID. In block 808, the processor may match the identified app ID to an activity profile stored in a database. For example, the processor may perform a look-up operation using the app ID to retrieve the corresponding activity profile for the selected app. In block 810, the processor may obtain usage information from the activity profile matched to the selected app. In other words, the matching activity profile may include the resource usage information, such as expected battery usage/power consumption while executing the app, the increase to device temperatures associated with the app, and hardware blocks historically used by the app. In block 310, the processor may determine an operating policy based on the obtained usage information. In block 208, the processor may manage (or cause another processor to manage) resources based on the determined operating policy. For example, the thermal mitigation policy may be adjusted and implemented to suit the historical hardware usage experienced by the selected app over the lifetime of the mobile device.

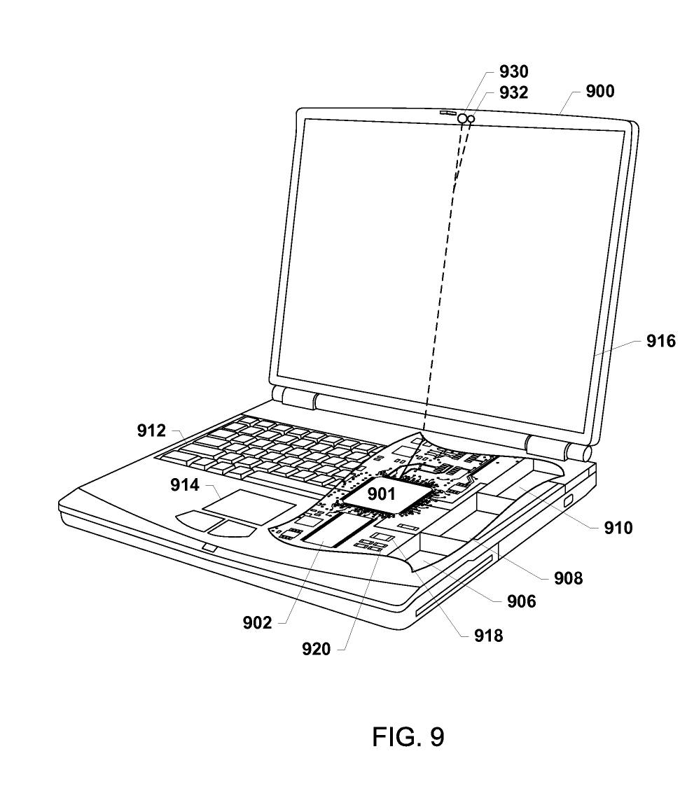

Various forms of computing devices (or mobile computing devices), including personal computers and laptop computers, may be used to implementing the various aspects. Such computing devices typically include the components illustrated in FIG. 9, which illustrates an example laptop computing device 900. Many laptop computers include a touch pad 914 that serves as the computer's pointing device, and thus may receive drag, scroll, and flick gestures similar to those implemented on mobile computing devices equipped with a touch screen display and described above. Such a laptop computing device 900 generally includes a processor 901 coupled to volatile internal memory 902 and a large capacity nonvolatile memory, such as a disk drive 906. The laptop computing device 900 may also include a compact disc (CD) and/or DVD drive 908 coupled to the processor 901. The laptop computing device 900 may also include a number of connector ports 910 coupled to the processor 901 for establishing data connections or receiving external memory devices, such as a network connection circuit for coupling the processor 901 to a network. The laptop computing device 900 may have one or more short-range radio signal transceivers 918 (e.g., Peanut®, Bluetooth®, Zigbee®, RF radio) and antennas 920 for sending and receiving wireless signals. In a laptop or notebook configuration, the computer housing includes the touch pad 914, the keyboard 912, and the display 916 all coupled to the processor 901. Other configurations of the laptop mobile computing device may include a computer mouse or trackball coupled to the processor (e.g., via a USB input) as are well known, which may also be used in conjunction with the various aspects. In an aspect, the laptop computing device 900 may also include various sensors, such as a camera 930 and a microphone 932, connected to the processor 901 and configured to receive sensor data.

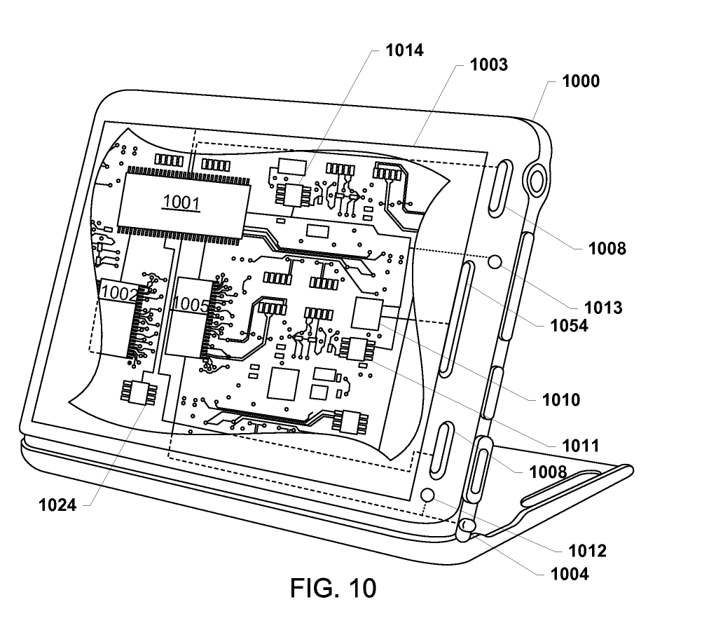

FIG. 10 is a system block diagram of a smartphone-type mobile computing device 1000 suitable for use with various aspects. The smartphone mobile computing device 1000 may include a processor 1001 coupled to internal memory 1002, a display 1003 (e.g., a touchscreen display), and to a speaker 1054. Additionally, the smartphone mobile computing device 1000 may include an antenna 1004 for sending and receiving electromagnetic radiation that may be connected to a wireless data link and/or long-range wireless signal transceiver 1005, such as a cellular network or WiFi radio, coupled to the processor 1001 and capable of communicating over a wide area wireless communication network. Smartphone mobile computing devices 1000 may include a separate short-range radio transceiver 1024 capable of communicating or pairing with other mobile computing devices. Smartphone mobile computing devices 1000 typically may also include menu selection buttons or rocker switches 1008 for receiving user inputs. Additionally, the smartphone mobile computing device 1000 may include an accelerometer 1010, a gyroscope 1011, and a GPS receiver chip 1014 coupled to the processor 1001. In an aspect, the smartphone mobile computing device 1000 may also include a microphone 1012 and a camera 1013 coupled to the processor 1001.

The processors 901 and 1001 may be any programmable microprocessor, microcomputer or multiple processor chip or chips that can be configured by software instructions (applications) to perform a variety of functions, including the functions of the various aspects described above. In the various devices, multiple processors may be provided, such as one processor dedicated to wireless communication functions and one processor dedicated to running other applications. Typically, software applications may be stored in the internal memory 902 and 1002 before they are accessed and loaded into the processors 901 and 1001. The processors 901 and 1001 may include internal memory sufficient to store the application software instructions. In many devices the internal memory may be a volatile or nonvolatile memory, such as flash memory, or a mixture of both. For the purposes of this description, a general reference to memory refers to memory accessible by the processors 901 and 1001 including internal memory or removable memory plugged into the various devices and memory within the processors 901 and 1001.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The operations of a method or algorithm disclosed herein may be embodied in a processor-executable software module that may be stored on a non-transitory processor-readable or computer-readable storage medium. Non-transitory processor-readable storage media may be any available media that may be accessed by a computer or processor. By way of example, and not limitation, non-transitory computer-readable and processor-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable and processor-readable media. Additionally, the operations of a method or algorithm may reside as one or any combination or set of codes and/or instructions on a tangible, non-transitory machine readable medium and/or computer-readable medium that may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for dynamically improving user experience in a mobile device, comprising:
periodically aggregating usage information and storing the aggregated usage information within a stored activity profile, wherein the usage information includes data from application programming interface (API) messages that indicate resource usage;
detecting a current circumstance based on activity information that is associated with the stored activity profile;
determining an operating policy based on the aggregated usage information of the stored activity profile; and
managing resources of the mobile device based on the determined operating policy.

2. The method of claim 1, wherein periodically aggregating usage information and storing the aggregated usage information within the stored activity profile comprises:
obtaining the usage information including metadata indicating characteristics of the current circumstance, data from the API messages, and from current usage data from hardware, software, and firmware;
aggregating the obtained usage information; and
storing the aggregated usage information in a database in relation to the current circumstance.

3. The method of claim 2, wherein obtaining current usage data from hardware, software, and firmware comprises:
gathering messages that are transmitted while the current circumstance exists, wherein the gathered messages indicate at least one of device temperatures, software notifications, firmware notifications, and power meters.

4. The method of claim 1, wherein the operating policy indicates at least one of a subscription/technology priority, a power consumption threshold, a thermal threshold, an activation/energized state, and a frequency for performing operations associated with a subsystem.

5. The method of claim 1, wherein detecting a current circumstance based on activity information that is associated with the stored activity profile comprises:
monitoring current activity information related to user activity; and
identifying the current circumstance based on the monitored current activity information,
wherein the monitored current activity information includes at least one a current application executing at a foreground, an interrupt, a detected user input, a state of an operating system, sensor data, a time of day, a user credential, and location information.

6. The method of claim 1, wherein determining an operating policy based on the aggregated usage information of the stored activity profile comprises:
determining whether the current circumstance has changed from a previous circumstance;
matching the current circumstance to the stored activity profile when the current circumstance has changed;
obtaining the aggregated usage information from a matched activity profile; and
determining the operating policy based on the obtained aggregated usage information.

7. The method of claim 1, wherein determining an operating policy based on the aggregated usage information of the stored activity profile comprises:
matching the current circumstance to the stored activity profile;
determining whether the current circumstance has changed from a previous circumstance;
determining whether the aggregated usage information in a matched activity profile has changed from a previous state;
obtaining the aggregated usage information from the matched activity profile when the current circumstance has changed;
obtaining the aggregated usage information from the matched activity profile when the aggregated usage information in the stored activity profile has changed; and
determining the operating policy based on the obtained aggregated usage information.

8. The method of claim 1, wherein determining an operating policy based on the aggregated usage information of the stored activity profile comprises adjusting an existing operating policy based on the aggregated usage information of the stored activity profile.

9. The method of claim 1, wherein detecting a circumstance comprises determining that a new application has been selected to execute in a foreground of an operating system, and
wherein determining an operating policy based on the aggregated usage information of the stored activity profile comprises:
identifying an application identifier for the new application that has been selected;
matching the identified application identifier to the stored activity profile;
obtaining the aggregated usage information from a matched activity profile; and
determining the operating policy based on the obtained aggregated usage information.

10. The method of claim 1, wherein managing resources of the mobile device based on the determined operating policy comprises at least one of adjusting a power consumption, adjusting a processing frequency, performing blanking based on priorities, and changing an activation state.

11. The method of claim 1, wherein managing resources of the mobile device based on the determined operating policy comprises:
determining whether the determined operating policy will result in an unwanted operating condition;
managing resources of the mobile device based on the determined operating policy when the determined operating policy will not result in the unwanted operating condition; and
overriding the determined operating policy when the determined operating policy will result in the unwanted operating condition.

12. A mobile device, comprising:
means for periodically aggregating usage information and storing the aggregated usage information within a stored activity profile, wherein the usage information includes data from application programming interface (API) messages that indicate resource usage;
means for detecting a current circumstance based on activity information that is associated with the stored activity profile;
means for determining an operating policy based on the aggregated usage information of the stored activity profile; and
means for managing resources of the mobile device based on the determined operating policy.

13. The mobile device of claim 12, wherein means for periodically aggregating usage information and storing the aggregated usage information within the stored activity profile comprises:
means for obtaining the usage information including metadata indicating characteristics of the current circumstance, data from the API messages, and from current usage data from hardware, software, and firmware;
means for aggregating the obtained usage information; and
means for storing the aggregated usage information in a database in relation to the current circumstance.

14. The mobile device of claim 13, wherein means for obtaining current usage data from hardware, software, and firmware comprises:
means for gathering messages that are transmitted while the current circumstance exists, wherein the gathered messages indicate at least one of device temperatures, software notifications, firmware notifications, and power meters.

15. The mobile device of claim 12, wherein the operating policy indicates at least one of a subscription/technology priority, a power consumption threshold, a thermal threshold, an activation/energized state, and a frequency for performing operations associated with a subsystem.

16. The mobile device of claim 12, wherein means for detecting a current circumstance based on activity information that is associated with the stored activity profile comprises:
means for monitoring current activity information related to user activity; and
means for identifying the current circumstance based on the monitored current activity information,
wherein the monitored current activity information includes at least one a current application executing at a foreground, an interrupt, a detected user input, a state of an operating system, sensor data, a time of day, a user credential, and location information.

17. The mobile device of claim 12, wherein means for determining an operating policy based on the aggregated usage information of the stored activity profile comprises:
means for determining whether the current circumstance has changed from a previous circumstance;
means for matching the current circumstance to the stored activity profile when the current circumstance has changed;
means for obtaining the aggregated usage information from a matched activity profile; and
means for determining the operating policy based on the obtained aggregated usage information.

18. The mobile device of claim 12, wherein means for determining an operating policy based on the aggregated usage information of the stored activity profile comprises:
means for matching the current circumstance to the stored activity profile;
means for determining whether the current circumstance has changed from a previous circumstance;
means for determining whether usage information in a matched activity profile has changed from a previous state;
means for obtaining the aggregated usage information from the matched activity profile when the current circumstance has changed;
means for obtaining the aggregated usage information from the matched activity profile when usage information in the stored activity profile has changed; and
means for determining the operating policy based on the obtained aggregated usage information.

19. The mobile device of claim 12, wherein means for determining an operating policy based on the aggregated usage information of the stored activity profile comprises means for adjusting an existing operating policy based on the aggregated usage information of the stored activity profile.

20. The mobile device of claim 12, wherein means for detecting a circumstance comprises determining that a new application has been selected to execute in a foreground of an operating system, and
wherein means for determining an operating policy based on the aggregated usage information of the stored activity profile comprises:
means for identifying an application identifier for the new application that has been selected;
means for matching the identified application identifier to the stored activity profile;
means for obtaining the aggregated usage information from a matched activity profile; and
means for determining the operating policy based on the obtained aggregated usage information.

21. The mobile device of claim 12, wherein means for managing resources of the mobile device based on the determined operating policy comprises at least one of means for adjusting a power consumption, means for adjusting a processing frequency, means for performing blanking based on priorities, and means for changing an activation state.

22. The mobile device of claim 12, wherein means for managing resources of the mobile device based on the determined operating policy comprises:
means for determining whether the determined operating policy will result in an unwanted operating condition;
means for managing resources of the mobile device based on the determined operating policy when the determined operating policy will not result in the unwanted operating condition; and
means for overriding the determined operating policy when the determined operating policy will result in the unwanted operating condition.

23. A mobile device, comprising:
a memory; and
a processor coupled to the memory and configured with processor-executable instructions to perform operations comprising:
periodically aggregating usage information and storing the aggregated usage information within a stored activity profile, wherein the usage information includes data from application programming interface (API) messages that indicate resource usage;
detecting a current circumstance based on activity information that is associated with the stored activity profile;
determining an operating policy based on the aggregated usage information of the stored activity profile; and
managing resources of the mobile device based on the determined operating policy.

24. The mobile device of claim 23, wherein the processor is configured with processor-executable instructions to perform operations such that periodically aggregating usage information and storing the aggregated usage information within the stored activity profile comprises:
obtaining the usage information including metadata indicating characteristics of the current circumstance, data from the API messages, and from current usage data from hardware, software, and firmware;
aggregating the obtained usage information; and
storing the aggregated usage information in a database in relation to the current circumstance.

25. The mobile device of claim 24, wherein the processor is configured with processor-executable instructions to perform operations such that obtaining current usage data from hardware, software, and firmware comprises:
gathering messages that are transmitted while the current circumstance exists, wherein the gathered messages indicate at least one of device temperatures, software notifications, firmware notifications, and power meters.

26. The mobile device of claim 23, wherein the operating policy indicates at least one of a subscription/technology priority, a power consumption threshold, a thermal threshold, an activation/energized state, and a frequency for performing operations associated with a subsystem.

27. The mobile device of claim 23, wherein the processor is configured with processor-executable instructions to perform operations such that detecting a current circumstance based on activity information that is associated with the stored activity profile comprises:
monitoring current activity information related to user activity; and
identifying the current circumstance based on the monitored current activity information,
wherein the monitored current activity information includes at least one a current application executing at a foreground, an interrupt, a detected user input, a state of an operating system, sensor data, a time of day, a user credential, and location information.

28. The mobile device of claim 23, wherein the processor is configured with processor-executable instructions to perform operations such that determining an operating policy based on the aggregated usage information of the stored activity profile comprises:
determining whether the current circumstance has changed from a previous circumstance;
matching the current circumstance to the stored activity profile when the current circumstance has changed;
obtaining the aggregated usage information from a matched activity profile; and
determining the operating policy based on the obtained aggregated usage information.

29. The mobile device of claim 23, wherein the processor is configured with processor-executable instructions to perform operations such that determining an operating policy based on the aggregated usage information of the stored activity profile comprises:
matching the current circumstance to the stored activity profile;
determining whether the current circumstance has changed from a previous circumstance;
determining whether usage information in a matched activity profile has changed from a previous state;
obtaining the aggregated usage information from the matched activity profile when the current circumstance has changed;
obtaining the aggregated usage information from the matched activity profile when usage information in the stored activity profile has changed; and
determining the operating policy based on the obtained aggregated usage information.

30. The mobile device of claim 23, wherein the processor is configured with processor-executable instructions to perform operations such that determining an operating policy based on the aggregated usage information of the stored activity profile comprises adjusting an existing operating policy based on the aggregated usage information of the stored activity profile.

31. The mobile device of claim 23, wherein the processor is configured with processor-executable instructions to perform operations such that detecting a circumstance comprises determining that a new application has been selected to execute in a foreground of an operating system, and
wherein the processor is configured with processor-executable instructions to perform operations such that determining an operating policy based on the aggregated usage information of the stored activity profile comprises:
identifying an application identifier for the new application that has been selected;
matching the identified application identifier to the stored activity profile;
obtaining the aggregated usage information from a matched activity profile; and
determining the operating policy based on the obtained aggregated usage information.

32. The mobile device of claim 23, wherein the processor is configured with processor-executable instructions to perform operations such that managing resources of the mobile device based on the determined operating policy comprises at least one of adjusting a power consumption, adjusting a processing frequency, performing blanking based on priorities, and changing an activation state.

33. The mobile device of claim 23, wherein the processor is configured with processor-executable instructions to perform operations such that managing resources of the mobile device based on the determined operating policy comprises:
determining whether the determined operating policy will result in an unwanted operating condition;
managing resources of the mobile device based on the determined operating policy when the determined operating policy will not result in the unwanted operating condition; and
overriding the determined operating policy when the determined operating policy will result in the unwanted operating condition.

34. A non-transitory processor-readable storage medium having stored thereon processor-executable software instructions configured to cause a processor of a mobile device to perform operations comprising:
periodically aggregating usage information and storing the aggregated usage information within a stored activity profile, wherein the usage information includes data from application programming interface (API) messages that indicate resource usage;
detecting a current circumstance based on activity information that is associated with the stored activity profile;
determining an operating policy based on the aggregated usage information of the stored activity profile; and
managing resources of the mobile device based on the determined operating policy.

35. The non-transitory processor-readable storage medium of claim 34, wherein the stored processor-executable software instructions are configured to cause the processor of the mobile device to perform operations such that periodically aggregating usage information and storing the aggregated usage information within the stored activity profile comprises:
obtaining the usage information including metadata indicating characteristics of the current circumstance, data from the API messages, and from current usage data from hardware, software, and firmware;
aggregating the obtained usage information; and
storing the aggregated usage information in a database in relation to the current circumstance.

36. The non-transitory processor-readable storage medium of claim 35, wherein the stored processor-executable software instructions are configured to cause the processor of the mobile device to perform operations such that obtaining current usage data from hardware, software, and firmware comprises:
gathering messages that are transmitted while the current circumstance exists, wherein the gathered messages indicate at least one of device temperatures, software notifications, firmware notifications, and power meters.

37. The non-transitory processor-readable storage medium of claim 34, wherein the operating policy indicates at least one of a subscription/technology priority, a power consumption threshold, a thermal threshold, an activation/energized state, and a frequency for performing operations associated with a subsystem.

38. The non-transitory processor-readable storage medium of claim 34, wherein the stored processor-executable software instructions are configured to cause the processor of the mobile device to perform operations such that detecting a current circumstance based on activity information that is associated with the stored activity profile comprises:
monitoring current activity information related to user activity; and
identifying the current circumstance based on the monitored current activity information,
wherein the monitored current activity information includes at least one a current application executing at a foreground, an interrupt, a detected user input, a state of an operating system, sensor data, a time of day, a user credential, and location information.

39. The non-transitory processor-readable storage medium of claim 34, wherein the stored processor-executable software instructions are configured to cause the processor of the mobile device to perform operations such that determining an operating policy based on the aggregated usage information of the stored activity profile comprises:
determining whether the current circumstance has changed from a previous circumstance;
matching the current circumstance to the stored activity profile when the current circumstance has changed;
obtaining the aggregated usage information from a matched activity profile; and
determining the operating policy based on the obtained aggregated usage information.

40. The non-transitory processor-readable storage medium of claim 34, wherein the stored processor-executable software instructions are configured to cause the processor of the mobile device to perform operations such that determining an operating policy based on the aggregated usage information of the stored activity profile comprises:
matching the current circumstance to the stored activity profile;
determining whether the current circumstance has changed from a previous circumstance;
determining whether usage information in a matched activity profile has changed from a previous state;
obtaining the aggregated usage information from the matched activity profile when the current circumstance has changed;
obtaining the aggregated usage information from the matched activity profile when usage information in the stored activity profile has changed; and
determining the operating policy based on the obtained aggregated usage information.

41. The non-transitory processor-readable storage medium of claim 34, wherein the stored processor-executable software instructions are configured to cause the processor of the mobile device to perform operations such that determining an operating policy based on the aggregated usage information of the stored activity profile comprises adjusting an existing operating policy based on the aggregated usage information of the stored activity profile.

42. The non-transitory processor-readable storage medium of claim 34, wherein the stored processor-executable software instructions are configured to cause the processor of the mobile device to perform operations such that detecting a circumstance comprises determining that a new application has been selected to execute in a foreground of an operating system, and
wherein the stored processor-executable software instructions are configured to cause the processor of the mobile device to perform operations such that determining an operating policy based on the aggregated usage information of the stored activity profile comprises:
identifying an application identifier for the new application that has been selected;
matching the identified application identifier to the stored activity profile;
obtaining the aggregated usage information from a matched activity profile; and
determining the operating policy based on the obtained aggregated usage information.

43. The non-transitory processor-readable storage medium of claim 34, wherein the stored processor-executable software instructions are configured to cause the processor of the mobile device to perform operations such that managing resources of the mobile device based on the determined operating policy comprises at least one of adjusting a power consumption, adjusting a processing frequency, performing blanking based on priorities, and changing an activation state.

44. The non-transitory processor-readable storage medium of claim 34, wherein the stored processor-executable software instructions are configured to cause the processor of the mobile device to perform operations such that managing resources of the mobile device based on the determined operating policy comprises:
determining whether the determined operating policy will result in an unwanted operating condition;
managing resources of the mobile device based on the determined operating policy when the determined operating policy will not result in the unwanted operating condition; and
overriding the determined operating policy when the determined operating policy will result in the unwanted operating condition.
